(19) United States
(12) Patent Application Publication
(10) Pub. No.: US 2017/0286562 A1
(43) Pub. Date: Oct. 5, 2017

(54) INFORMATION PROCESSING APPARATUS, DATA PROVIDING SYSTEM, AND DATA PROVIDING METHOD

(71) Applicant: FUJITSU LIMITED, Kawasaki-shi (JP)

(72) Inventor: Shinya YAMAMURA, Fukuoka (JP)

(73) Assignee: FUJITSU LIMITED, Kawasaki-shi (JP)

(21) Appl. No.: 15/464,584

(22) Filed: Mar. 21, 2017

(30) Foreign Application Priority Data
Mar. 31, 2016 (JP) 2016-072477

(51) Int. Cl. G06F 17/30; H04L 29/08

(52) U.S. Cl. CPC G06F 17/30902; G06F 17/30964; H04L 67/2842; H04L 67/1097

(57) ABSTRACT

An information processing apparatus includes a memory configured to store data and time information indicating the time of storing the data, a processor coupled to the memory and configured to receive, from a request source device, a request message including an identifier corresponding to the data and a condition related to time corresponding to the data, search the memory for required data that corresponds to the identifier and the time information satisfying the condition, acquire the required data from the memory when the required data is stored in the memory, acquire the data from another device when the required data is not stored in the memory, and transmit the required data to the request source device.

### CROSS-REFERENCE TO RELATED APPLICATION

This application is based upon and claims the benefit of priority of the prior Japanese Patent Application No. 2016-072477, filed on Mar. 31, 2016, the entire contents of which are incorporated herein by reference.

### FIELD

The embodiments discussed herein are related to an information processing apparatus, a data providing system, a data providing method, and a data providing program.

### BACKGROUND

In order to realize the Internet of Things (IoT), an inter-enterprise collaboration system for exchanging data with a highly real-time nature such as traffic congestion information between the enterprises is being studied. In, for example, a vertically integrated inter-enterprise collaboration system, applications of multiple enterprises collect data from devices and accumulate such data in their respective databases based on individual platforms, and refer to the databases each other via an application programming interface (API). In addition, in a horizontally integrated inter-enterprise collaboration system, applications of multiple enterprises share a platform, such that data collected from devices are flexibly routed to various servers via a connection in a mesh shape.

In these inter-enterprise collaboration systems, a user who asks for information individually accesses a database to acquire desired data. This inhibits use of a cache server, which inhibits information to be shared between users. This makes it difficult to reduce traffic in the network in inter-enterprise collaboration systems.

In addition, it is known that desired data may be cached in a terminal of a user who accesses the Internet, for the cache to be used when accessing the Internet (see, for example, Japanese Laid-open Patent Publication No. 2000-35935). However, since the data is not available to be shared between users, it is difficult to effectively reduce traffic in a network.

Against this backdrop, applying information centric networking (ICN) (see, for example, L. Zhang et al., “Named data networking (NDN) project”, PARC Technical Report 2010-003, 2010 and V. Jscobson et al., “Networking named content”, ACM CoNext, pp. 1-12, 2009) that is a technology to perform communication based on name of data, differently from communication based on internet protocol (IP) addresses and the like, to an IoT system such as an inter-enterprise collaboration system. In the ICN, a data request message transmitted by a client device is transferred to a server that holds the data and is located closest, through a relay device at each node in the network.

The server generates and transmits a response message that includes the requested data, to the client device via a relay device at each node. At this time, the relay device at each node caches data, and when the request message is subsequently transmitted from another client device, the relay device transmits the cached data to that client device.

Thus, in the ICN, data can be shared between client devices, enabling a relay device in the closest node to provide data to a client device. Traffic in a network is thereby effectively reduced. Note that, a content centric networking (CCN), a named data networking (NDN), and the like, are known as a research project on the ICN.

### SUMMARY

According to an aspect of the invention, an information processing apparatus includes a memory configured to store data and time information indicating the time of storing the data, and a processor coupled to the memory and configured to receive, from a request source device, a request message including an identifier corresponding to the data and a condition related to time corresponding to the data, search the memory for required data that corresponds to the identifier and the time information satisfying the condition, acquire the required data from the memory when the required data is stored in the memory, acquire the required data from another device when the required data is not stored in the memory, and transmit the required data to the request source device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a data providing system;

FIG. 2 is a configuration diagram illustrating an example of a request source device;

FIG. 3 is a configuration diagram illustrating an example of a relay device;

FIG. 4 is a configuration diagram illustrating an example of a functional configuration of the relay device;

FIG. 5 is a diagram illustrating examples of a request management table and a database;

FIG. 6 is a flowchart illustrating an example of reception processing of a request message;

FIG. 7 is a flowchart illustrating an example of transmission processing of a request message;

FIG. 8 is a flowchart illustrating an example of transmission processing of a response message including cached data;

FIG. 9 is a flowchart illustrating an example of reception processing of a response message;

FIG. 10 is a flowchart illustrating an example of transmission processing of a response message including data acquired from a data providing device;

FIG. 11 is a configuration diagram illustrating a comparative example of a sensor system;

FIG. 12 is a configuration diagram illustrating another comparative example of the sensor system;

FIG. 13 is a configuration diagram illustrating the other comparative example of the sensor system;

FIG. 14 is a configuration diagram illustrating an embodiment of a sensor system;

FIG. 15 is a configuration diagram illustrating the embodiment of the sensor system;

FIG. 16 is a configuration diagram illustrating the embodiment of the sensor system;

FIG. 17 is a diagram illustrating an example of a request management table in the sensor system;

FIG. 18 is a configuration diagram illustrating the embodiment of the sensor system;

FIG. 19 is a diagram illustrating an example of a database in the sensor system;

FIG. 20 is a diagram illustrating another example of the request management table in the sensor system;

FIG. 21 is a diagram illustrating another example of the database in the sensor system;

FIG. 22 is a configuration diagram illustrating an embodiment of a traffic information system;

FIG. 23 is a sequence diagram illustrating an example of operation of the traffic information system when no relevant data is cached in a relay device;

FIG. 24 is a diagram illustrating examples of a request management table and a database in the traffic information system;

FIG. 25 is a sequence diagram illustrating an example of operation of the traffic information system when a relevant data is cached in the relay device;

FIG. 26 is a diagram illustrating other examples of the request management table and the database in the traffic information system; and

FIG. 27 is a sequence diagram illustrating an example of operation of the traffic information system when no response message is received from a data providing server.

### DESCRIPTION OF EMBODIMENTS

When a relay device transmits cached data to a client device in the ICN, chances are that old data has been provided to the client device depending on the timing when the cached data was cached. Therefore, if the ICN is applied, for example, to the above-mentioned inter-enterprise collaboration system, the system may not function effectively when data with a highly real-time nature is exchanged.

The present technology is thus developed in view of the above-mentioned problem, with its objective to provide an information processing apparatus, a data providing system, a data providing method, and a data providing program that enable data with a highly real-time nature to be effectively provided to client devices.

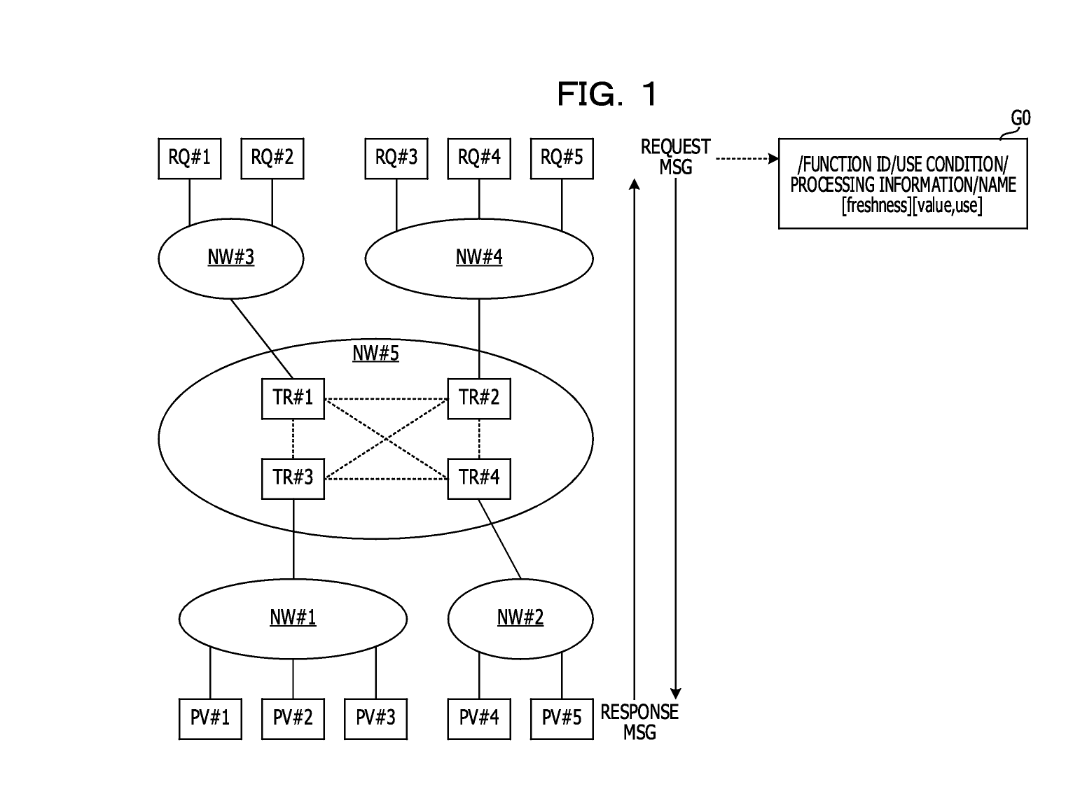

FIG. 1 is a configuration diagram illustrating an example of a data providing system. The data providing system includes a request source device RQ#1 to RQ#5 that each requests data based on an application, a data providing device PV#1 to PV#5 that each provides data, and a relay device TR#1 to TR#4 that relays communication between the request source device RQ#1 to RQ#5 and the data providing device PV#1 to PV#5.

The request source device RQ#1 to RQ#5, the data providing device PV#1 to PV#5, and the relay device TR#1 to TR#4 each performs communication, based on the technology of the ICN, as an example. Therefore, the request source device RQ#1 to RQ#5, the data providing device PV#1 to PV#5, and the relay device TR#1 to TR#4 each performs communication based on data names rather than IP addresses.

Examples of the request source device RQ#1 to RQ#5 include a terminal such as a smartphone and a personal computer, and a client device such as a server. The request source device RQ#1 to RQ#5 is coupled to the relay device TR#1, TR#2 via, for example, a network NW#3, NW#4 such as a wireless local area network (LANs).

Examples of the data providing device PV#1 to PV#5 include a server, a sensor device, and the like. The data providing device PV#1 to PV#5 are coupled to the relay device TR#3, TR#4 via networks NW#1, NW#2 such as LANs.

The relay device TR#1 to TR#4 is provided in the network NW#5 and is connected in a mesh shape, as an example. The relay device TR#1 to TR#4 relays request messages (request MSGs) transmitted by the request source device RQ#1 to RQ#5 to the data providing device PV#1 to PV#5. The relay device TR#1 to TR#4 relays response messages (response MSGs) transmitted by the data providing device PV#1 to PV#5 to the request source device RQ#1 to RQ#5.

The relay device TR#1 to TR#4 is an example of an information processing apparatus, and when relaying response messages caches request target data included therein in a database. When the request messages are received again, the relay device TR#1 to TR#4 searches the database. When the request target data is present in the database, the relay device TR#1 to TR#4 transmits a response message that includes relevant cached data to the request source device RQ#1 to RQ#5.

Each time the relay device TR#1 to TR#4 relays a response message from the data providing device PV#1 to PV#5, cached data is accumulated therein. This enables the relay device TR#1 to TR#4 to provide data to the request source device RQ#1 to RQ#5 in place of the data providing device PV#1 to PV#5. This thereby enables the request source device RQ#1 to RQ#5 to acquire data from the relay device TR#1 to TR#4 located closest, by transmitting a request message, and this accordingly enables traffic of the networks NW#1 and NW#2 to be reduced.

Symbol G0 illustrates an example of a request message. The request message is configured by inserting multiple items into a namespace with slashes (“/”) interposed therebetween. The request messages each include “function ID”, “use condition”, “processing information”, and “name”. The “function ID” is an identifier indicating application of functions of the present embodiment as described below.

The “use condition” is an example of a condition related to time associated with request target data of the request source device RQ#1 to RQ#5. Example of the use condition includes time elapsed after the request target data is generated, for example. However, the use condition is not limited thereto.

The relay device TR#1 to TR#4, when caching request target data, registers in a database current time, namely, the time of caching (hereinafter, “cached time”), along with the request target data. The relay device TR#1 to TR#4, when a request message is received, searches for cached data that satisfies the use condition regarding cached time, and transmits the relevant cached data included in the response message to the request source device RQ#1 to RQ#5. This thereby enables the request source device RQ#1 to RQ#5 to effectively acquire data with a highly real-time nature, by specifying a use condition. Note that the use condition is specified by a variable “freshness”, as an example.

The “processing information” is information for specifying processing for outputting a response message to the request source device RQ#1 to RQ#5. Examples of the processing information include a restriction condition (specified by a variable “value”) for restricting cached data to be transmitted to the request source device RQ#1 to RQ#5 and control information (specified by a variable “use”) indicating whether or not to transmit cached data when no data is acquired from the data providing device PV#1 to PV#5, for example. Note that there is no limitation to the processing information, and statistical processing or the like of data may be specified by the processing information.

The “name” is information for specifying request target data and is an example of an identifier associated with the request target data. The relay device TR#1 to TR#4 searches for cached data based on name.

In this way, request target data is specified by name and a use condition related to the time the request target data was generated is specified in the request message. In addition, a restriction condition for restricting data to be transmitted to the request source device RQ#1 to RQ#5, and control information indicating whether or not to transmit cached data when request target data is not acquired from the data providing device PV#1 to PV#5 are specified as the processing information in the request message. Description regarding the request source device RQ#1 to RQ#5 that transmits request messages and the relay device TR#1 to TR#4 that receives the request messages will follow.

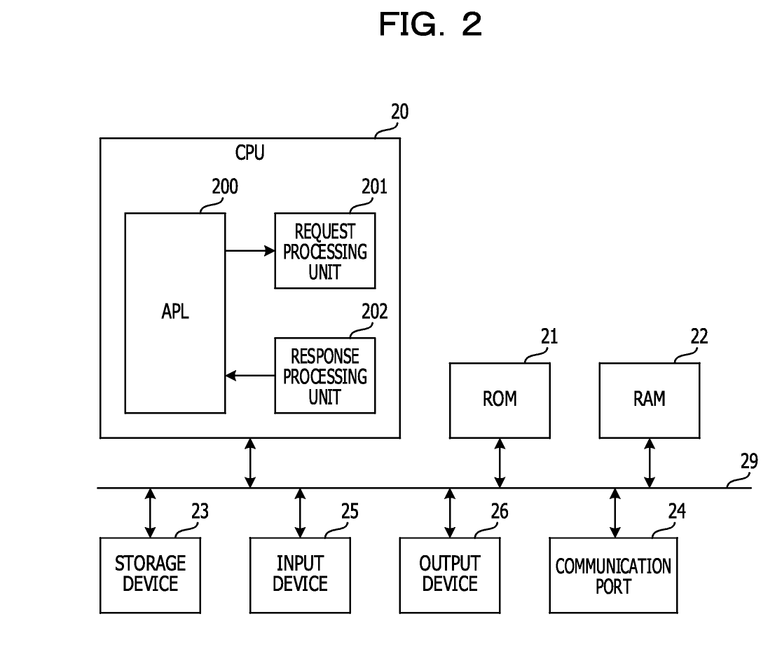

FIG. 2 is a configuration diagram illustrating an example of the request source device RQ#1 to RQ#5. The request source device RQ#1 to RQ#5 each includes a central processing unit (CPU) 20, a read only memory (ROM) 21, a random access memory (RAM) 22, a storage device 23, a communication port 24, an input device 25, and an output device 26. The CPU 20 is coupled to the ROM 21, the RAM 22, the storage device 23, the communication port 24, the input device 25, and the output device 26 via a bus 29, such that input and output of signals between each other are enabled.

A program to drive the CPU 20 is stored in the ROM 21. The RAM 22 functions as a working memory of the CPU 20. The communication port 24 is, for example, a wireless local area network (LAN) card or a network interface card (NIC) and processes communication with another device.

The input device 25 is a device to input information to the request source device RQ#1 to RQ#5. Examples of the input device 25 include a keyboard, a mouse, a touch panel, and the like. The input device 25 outputs the input information to the CPU 20 via the bus 29.

The output device 26 is a device to output information from the request source device RQ#1 to RQ#5. Examples of the output device 26 include a display, a touch panel, a printer, and the like. The output device 26 acquires information from the CPU 20 via the bus 29, and outputs the information.

The storage device 23 is a nonvolatile memory such as, for example, a hard disk drive (HDD) and an erasable programmable ROM (EPROM). Data acquired from the data providing device PV#1 to PV#5, the relay device TR#1 to TR#4, and the like, are stored in the storage device 23.

An application (APL) 200, a request processing unit 201, and a response processing unit 202 are formed as functions, by the CPU 20 reading the program from the ROM 21. The application 200 is software for providing predetermined services to users by utilizing data acquired from the data providing device PV#1 to PV#5 or the relay device TR#1 to TR#4. As described later, examples of the application 200 include an application to notify status of use of a conference room and an application to notify the information of a bus arriving in the shortest time, however, there is no limitation thereto.

The application 200 requests the request processing unit 201 to acquire data from the data providing device PV#1 to PV#5. Upon receiving the request from the application 200, the request processing unit 201 generates and transmits a request message via the communication port 24. The response processing unit 202 receives response messages from the data providing device PV#1 to PV#5 or the relay device TR#1 to TR#4, and acquires request target data from the response messages. The response processing unit 202 stores the request target data in the storage device 23 and informs the application 200 to that effect.

Based on such a configuration, the request source device RQ#1 to RQ#5 acquires data from the data providing device PV#1 to PV#5 or the relay device TR#1 to TR#4, and provides predetermined services to the users.

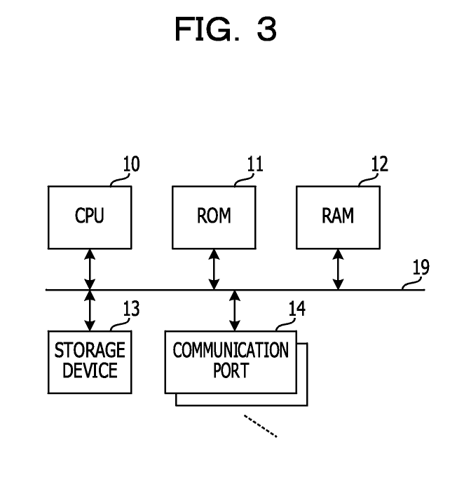

FIG. 3 is a configuration diagram illustrating an example of the relay device TR#1 to TR#4. The relay device TR#1 to TR#4 each includes a CPU 10, a ROM 11, a RAM 12, a storage device 13 such as an HDD or a nonvolatile memory, and multiple communication ports 14. The CPU 10 is coupled to the ROM 11, the RAM 12, the storage device 13, and the communication ports 14 via a bus 19 such that input and output of signals between each other are enabled.

A program to drive the CPU 10 is stored in the ROM 11. Programs within the ROM 11 include a data providing program that performs a data providing method of the embodiment.

The RAM 12 functions as a working memory of the CPU 10. A database and the like in which cached data is registered is stored in the storage device 13 which is an example of a storage unit. The communication ports 14 is a device equipped with a communication processing function in, for example, the physical layer (PHY)/media access control (MAC). The communication ports 14 process communication between the relay device and the other relay device TR#1 to TR#4, the request source device RQ#1 to RQ#5, and the data providing device PV#1 to PV#5.

The CPU 10 is an example of a computer that executes a program, and by reading the program from the ROM 11, the CPU 10 forms various kinds of functions for executing the data providing program, as described below.

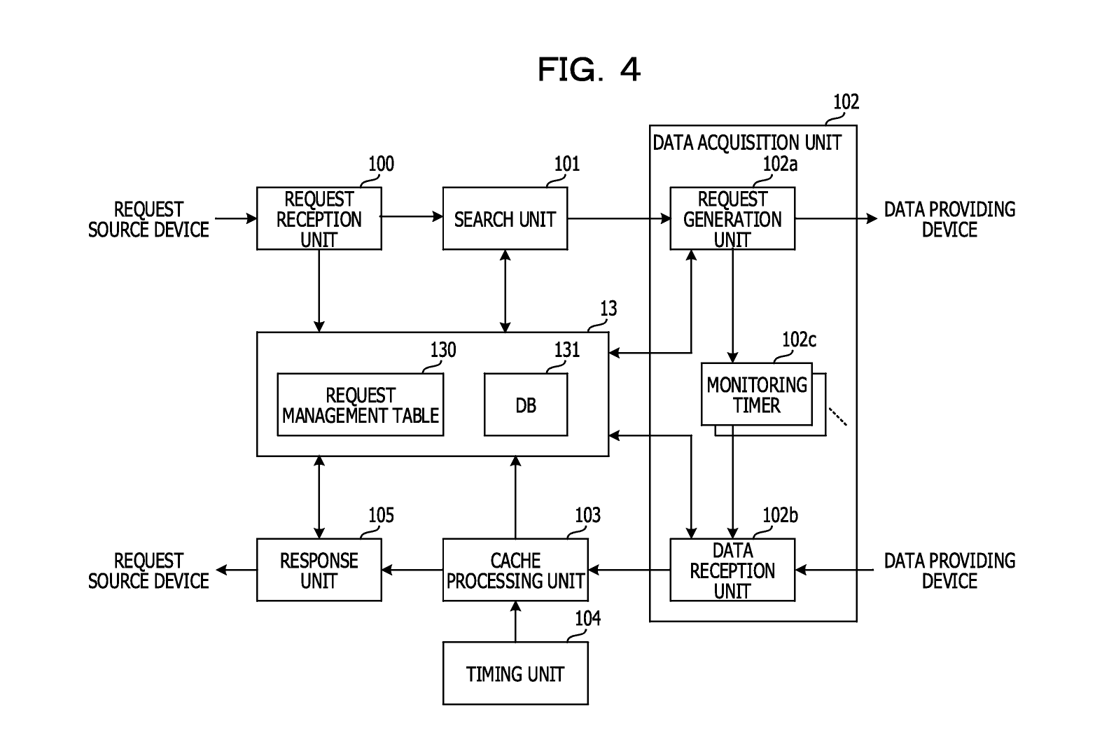

FIG. 4 is a configuration diagram illustrating an example of functional configurations of the relay device TR#1 to TR#4. The CPU 10 includes a request reception unit 100, a search unit 101, a data acquisition unit 102, a cache processing unit 103, a timing unit 104, and a response unit 105, as functions of the data providing program. In addition, a request management table 130 and a database 131 (DB) are stored in the storage device 13.

The request reception unit 100 is an example of a reception unit and receives a request message from the request source device RQ#1 to RQ#5 via the communication ports 14. The request reception unit 100 acquires from the request message, and stores in the request management table 130, a function ID, a use condition, processing information, and a name.

On recognizing the function ID, the request reception unit 100 registers in the request management table 130, the use condition, the processing information, and the name. The data providing method of the embodiment is thus performed. Note that when the function ID is not recognized by the request reception unit 100, search processing of cached data is performed solely based on the name, not on use condition or processing information. When the registration is completed, the request reception unit 100 notifies the search unit 101 to that effect.

Upon receiving the notice from the request reception unit 100, the search unit 101 searches the database 131 for cached data that matches the name specified in the request message and that satisfies the use condition regarding the cached time. Namely, the search unit 101 determines whether or not the cached data satisfies the use condition based on the cached time.

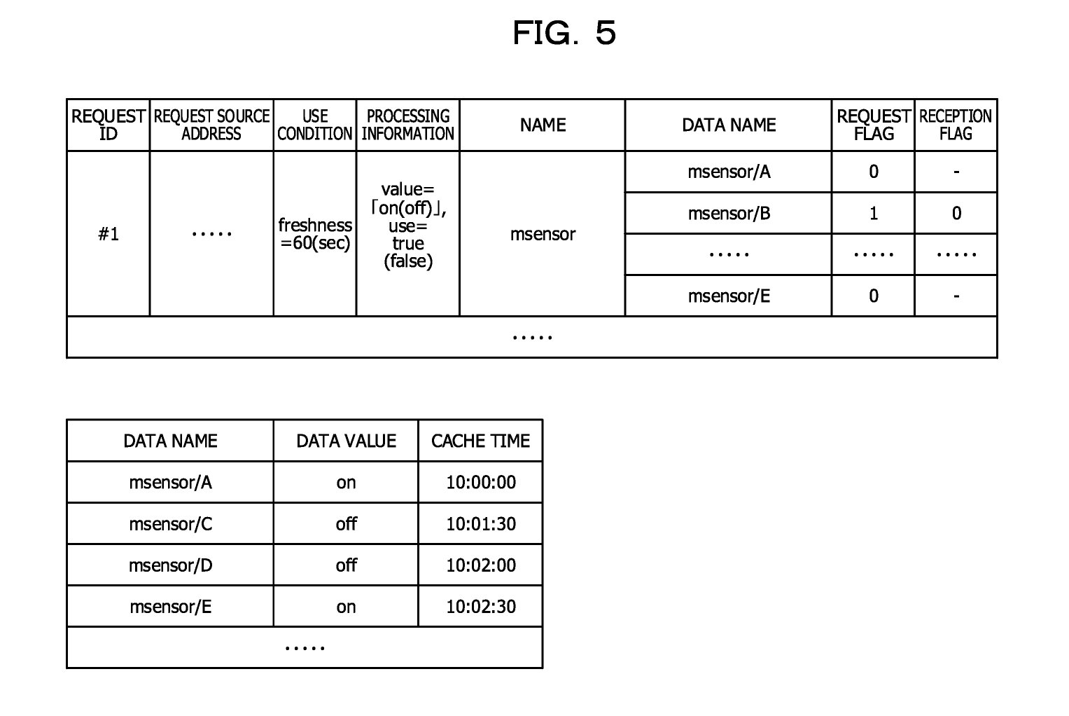

FIG. 5 illustrates examples of the request management table 130 and the database 131. In the database 131, a data name serving as a name of cached data, data value serving as value of the cached data, and cached time of the cached data are registered. Namely, data and its cached time are stored in the storage device 13. Here, the cached time is an example of time information indicating the time at which the data was stored. The present example of data value illustrates values (“on”: occupied and “off”: vacant) used in an after-mentioned search system for conference room availability. However, there is no limitation thereto.

In addition, a request ID, a request source address, a use condition, processing information, name, a data name, a request flag, and a reception flag are registered in the request management table 130.

The request ID is an identifier of a request message and is determined by the request reception unit 100. The request source address is an address of either of the request source device RQ#1 to RQ#5 that serves as a transmission source of the request message. The data name is a data name matching a name of request target data. The request flag indicates whether or not to send a request message to the data providing device PV#1 to PV#5, and the reception flag indicates whether a response message from the data providing device PV#1 to PV#5 has been received or not.

Upon receiving a request message, the request reception unit 100 determines the request ID and registers a transmission source address of the request message in the request management table 130. In addition, when the function ID is recognized, the request reception unit 100 registers the use condition, processing information, and the name in the request management table 130.

The search unit 101 searches the database 131 for a data name matching the name. The search unit 101 registers the data name matching the name, in the request management table 130. When the name is, for example, “msensor”, the search unit 101 searches the database 131 for data name “msensor/A” to “msensor/E” that includes “msensor”, and registers such in the request management table 130.

In addition, the search unit 101 determines whether or not a cached data matching the name satisfies the use condition by referencing cached time in the database 131. If, for example, “freshness=60 (sec)” is specified as the use condition, the search unit 101 determines that the cached data satisfies the use condition when the cached time is within a range of 60 seconds before the current time to the current time. On the other hand, when the cached time is older than 60 seconds before the current time, the search unit 101 determines that the cached data does not satisfy the use condition. Note that cached data that matches the name and satisfies the use condition regarding the cached time, namely, the request target data, is an example of specific data.

The search unit 101 sets the request flag in the request management table 130 to “0” for the cached data satisfying the use condition, and sets the request flag in the request management table 130 to “1” for the cached data not satisfying the use condition. In addition, when cached data matching the name is not registered in the database 131, the search unit 101 registers the name itself as the data name in the request management table 130 and sets the request flag thereof to “1”.

Referencing FIG. 4 again, upon setting request flags to all data names, the search unit 101 notifies the data acquisition unit 102 and the response unit 105 to that effect.

The data acquisition unit 102 is an example of an acquisition unit, and when a search by the search unit 101 found that cached data that matches the name and satisfies the use condition regarding the cached time is stored in the database 131, the data acquisition unit 102 acquires the cached data from the database 131. In addition, when the cached data is not stored in the database 131, the data acquisition unit 102 acquires the data from the data providing device PV#1 to PV#5.

More specifically, when cached data that matches the name and satisfies the use condition regarding the cached time is not registered in the database 131, the data acquisition unit 102 acquires the request target data satisfying the use condition from the data providing device PV#1 to PV#5. In addition, out of the cached data that matches the name, for the data that does not satisfy the use condition, the data acquisition unit 102 acquires the request target data that satisfies the use condition from the data providing device PV#1 to PV#5. At this time, the data acquisition unit 102 determines the acquisition destination of the request target data based on the request flags in the request management table 130.

More specifically, the data acquisition unit 102 includes a request generation unit 102a that generates request messages, a data reception unit 102b that receives response messages to the respective request messages, and monitoring timers 102c for monitoring reception of response messages. Note that the monitoring timers 102c are provided corresponding to each of the request messages generated.

Upon receiving the notice from the search unit 101, the request generation unit 102a references request flags in the request management table 130 and generates a request message that includes a name which is the name of data for which the request flag is “1”. The request generation unit 102a transmits the request message to the data providing device PV#1 to PV#5 via the communication ports 14.

The request generation unit 102a thereby makes a request for request target data that satisfies the use condition regarding the cached time from the data providing device PV#1 to PV#5, when the cached data matching the name is not registered in the database 131 or when the cached data satisfying the use condition regarding the cached time is not registered in the database 131. Upon transmitting the request message, the request generation unit 102a activates the monitoring timer 102c for monitoring reception of a response message corresponding to the request message.

The data reception unit 102b monitors reception of a response message using the monitoring timer 102c. On receiving a response message before the monitoring timer 102c expires, the data reception unit 102b stops the monitoring timer 102c and sets the reception flag in the request management table 130 to “1”. On the other hand, upon expiry of the monitoring timer 102c, the data reception unit 102b stops the monitoring timer 102c and sets the reception flags in the request management table 130 to “0”.

Upon setting the reception flag to “1”, the data reception unit 102b notifies the cache processing unit 103 to that effect together with the received response message. In addition, the data reception unit 102b references request flags in the request management table 130 and reads, from the database 131, cached data having a data name for which the request flag is “0”, and outputs the cached data to the response unit 105 via the cache processing unit 103.

Upon receiving the notice from the data reception unit 102b, the cache processing unit 103 caches request target data acquired from the data providing device PV#1 to PV#5, in the database 131. More specifically, the cache processing unit 103 acquires current time from the timing unit 104, and registers the current time in the database 131 along with the request target data included in the response message. The timing unit 104 clocks time, and the time is registered as the cached time in the database 131 by the cache processing unit 103. Note that the timing unit 104 performs time synchronization with the other relay device TR#1 to TR#4 and the data providing device PV#1 to PV#5 via the communication ports 14.

When caching of request target data included in all response messages is completed, the cache processing unit 103 notifies the response unit 105 to that effect.

The response unit 105 is an example of a transmission unit, and transmits data acquired by the data acquisition unit 102 to the request source device RQ#1 to RQ#5. More specifically, upon receiving the notice from the cache processing unit 103, the response unit 105 reads cached data cached by the cache processing unit 103, from the database 131. The response unit 105 generates a response message including the cached data and transmits the response message to the request source device RQ#1 to RQ#5 via the communication ports 14.

In addition, upon receiving cached data from the data reception unit 102b, the response unit 105 generates a response message including the cached data and transmits the response message to the request source device RQ#1 to RQ#5 via the communication ports 14.

In this way, the search unit 101 searches the database for cached data that matches the name specified by the request message and satisfies the use condition regarding the cached time. Namely, the search unit 101 searches the database 131 for cached data that matches the name of the request message and that is associated with time information satisfying the use condition. The data acquisition unit 102 acquires that cached data from the database 131, and the response unit 105 transmits the cached data to the request source device RQ#1 to RQ#5.

In addition, when no cached data that matches the name specified by the request message and satisfies the use condition regarding the cached time is registered in the database 131, the data acquisition unit 102 acquires request target data satisfying the use condition from the data providing device PV#1 to PV#5. The response unit 105 transmits that request target data to the request source device RQ#1 to RQ#5.

Therefore, the relay device TR#1 to TR#4 is able to search the database 131 for request target data satisfying a use condition set by the request source device RQ#1 to RQ#5, and to provide such request target data as cached data, or is able to acquire the request target data from the data providing device PV#1 to PV#5 and to provide such request target data. The relay device TR#1 to TR#4 are thereby enabled to effectively provide data with a highly real-time nature to the request source device RQ#1 to RQ#5.

In addition, for cached data that corresponds to the name but does not satisfy the use condition regarding the cached time, the data acquisition unit 102 acquires the request target data satisfying the use condition from the data providing device PV#1 to PV#5. Namely, for cached data that matches the name but is associated with cached time not satisfying the use condition, the data acquisition unit 102 acquires the request target data satisfying the use condition from the data providing device PV#1 to PV#5. This thereby enables the data acquisition unit 102 to only acquire the missing request target data from the data providing device PV#1 to PV#5 and transmit such to the request source device RQ#1 to RQ#5. This thereby enables traffic of the networks NW#1 and NW#2 to be reduced.

The response unit 105 transmits, out of request target data acquired by the data acquisition unit 102, data that satisfies a restriction condition indicated by the processing information in the request management table 130, to the request source device RQ#1 to RQ#5. In a case of the example of FIG. 5, the response unit 105 only transmits cached data for which the data value is “on”, and request target data acquired by the data acquisition unit 102, in accordance with the specification (“on”) by the variable “value”. This thereby reduces traffic of response messages transmitted by the relay device TR#1 to TR#4.

In addition, when the data acquisition unit 102 is unable to acquire request target data from the data providing device PV#1 to PV#5, the response unit 105 transmits the cached data matching the name and associated with cached time not satisfying the use condition to the request source device RQ#1 to RQ#5, based on control information indicated by the processing information in the request management table 130. In a case of the example of FIG. 5, in accordance with the specification (“true”) by the variable “use”, the response unit 105 reads cached data corresponding to the reception flag “0” and the data name “msensor/B” from the database 131, and transmits the cached data included in a response message. This thereby enables request source device RQ#1 to RQ#5 to acquire data that does not satisfy the use condition but is specified by the name of the request message.

Next, processing in the relay device TR#1 to TR#4 will be described.

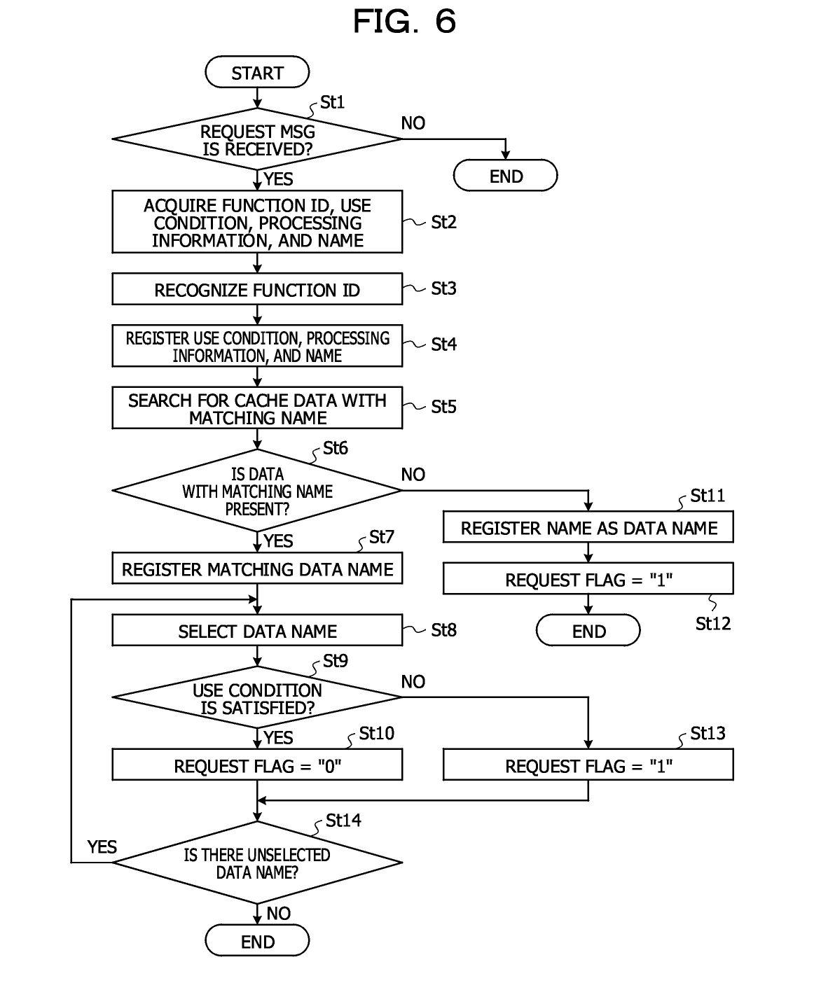

FIG. 6 is a flowchart illustrating an example of reception processing of a request message. The processing is periodically performed, for example.

The request reception unit 100 determines whether or not a request message is received (step St1). When no request message is received (step St1: No), the request reception unit 100 terminates the processing.

When a request message is received (step St1: Yes), the request reception unit 100 acquires a function ID, a use condition, processing information, and a name from the request message (step St2). At this time, the request reception unit 100 identifies the function ID, the use condition, the processing information, and the name, using slashes within the request message as marks.

Next, the request reception unit 100 recognizes the function ID (step St3), for example, by comparing the function ID with a predetermined value. Next, the request reception unit 100 registers the use condition, the processing information, and the name in the request management table 130 (step St4). The request reception unit 100 receives the request message from the request source device RQ#1 to RQ#5 in this manner. Next, the search unit 101 searches the database 131 for cached data matching the name (step St5).

Next, the search unit 101 determines whether or not the cached data matching the name is present (step St6). Namely, the search unit 101 determines whether or not the cached data having a matching data name is present.

When no cached data having a matching data name is present (step St6: No), the search unit 101 registers the name as the data name in the request management table 130 (step St11). Next, the search unit 101 sets the request flag for that data name to “1” (step St12). With this, when no cached data with a matching data name is present, a request message specifying request target data by its name is transmitted to the data providing device PV#1 to PV#5.

In addition, when cached data with a matching data name is present (step St6: Yes), the search unit 101 registers the data name for that cached data as the data name in the request management table 130 (step St7). Note that the search unit 101 registers data name of all applicable cached data with a matching data name.

Next, the search unit 101 selects one of the data name (step St8). Next, the search unit 101 determines whether or not a cached time of cached data having the selected data name satisfies the use condition (step St9). At this time, the search unit 101 performs determination processing by comparing cached time in the database 131 with the use condition in the request management table 130, based on the cached data having the selected data name.

When the cached time satisfies the use condition (step St9: Yes), the search unit 101 sets the request flag to “0” (step St10). For this reason, the request generation unit 102a will not request the data providing device PV#1 to PV#5, to provide data matching the data name of the cached data that satisfies the use condition regarding the cached time.

On the other hand, when the cached time does not satisfy the use condition (step St9: No), the search unit 101 sets the request flag to “1” (step St13). Therefore, the request generation unit 102a requests the data providing device PV#1 to PV#5 to provide data matching the data name of the cached data that has not satisfied the use condition regarding the cached time.

In this way, the search unit 101 searches the database 131 for the cached data that matches the name and is associated with the cached time that satisfies the use condition.

Next, the search unit 101 determines whether or not there is an unselected data name (step St14). When there is a data name not yet selected (step St14: Yes), the search unit 101 selects the unselected data name in step St8 and performs the processing of step St9 again. When there is no unselected data name (step St14: No), the search unit 101 terminates the processing. In this way, the reception processing of the request message is performed.

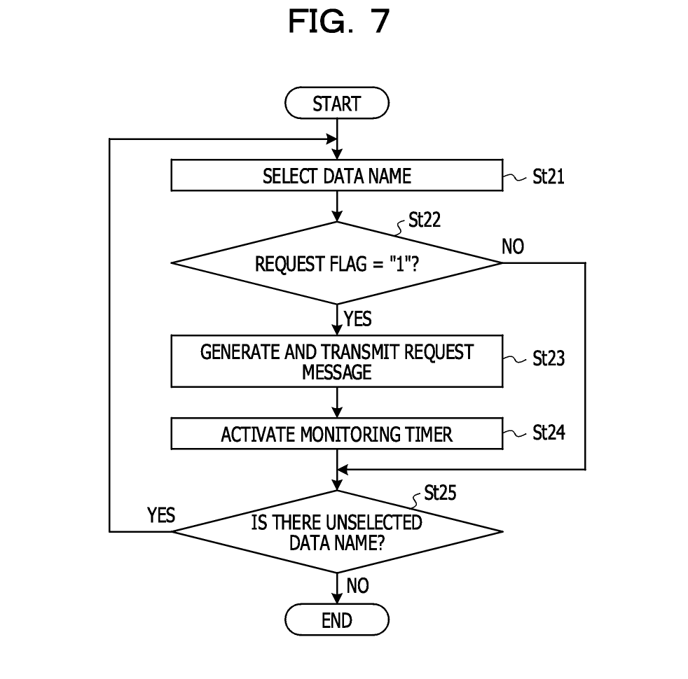

FIG. 7 is a flowchart illustrating an example of transmission processing of a request message. This processing is performed after the search unit 101 completes setting of request flags for all data names.

The request generation unit 102a selects one of data name in the request management table 130 (step St21). Next, the request generation unit 102a determines whether or not a request flag of the selected data name is “1” (step St22). When the request flag is “1” (step St22: Yes), the request generation unit 102a generates a request message that specifies the selected data name as a name, and transmits the request message to the data providing device PV#1 to PV#5 via the communication ports 14 (step St23).

In this way, when cached data that matches the name specified by the request message and is associated with cached time satisfying the use condition is not registered in the database 131, the data acquisition unit 102 acquires request target data satisfying the use condition from the data providing device PV#1 to PV#5. In addition, for the cached data that matches the name specified by the request message but does not satisfy the use condition regarding cached time, the data acquisition unit 102 acquires request target data satisfying the use condition from the data providing device PV#1 to PV#5.

Next, the request generation unit 102a activates the monitoring timers 102c for monitoring reception of a response message to each request message (step St24). Alternatively, when the request flag is “0” (step St22: No), the request generation unit 102a performs none of the processing of the respective steps St23 and St24.

This thereby enables the request generation unit 102a to request target data satisfying the use condition, from the data providing device PV#1 to PV#5, when there is no cached data matching the name, or when cached data matching the name is present but does not satisfy the use condition.

Next, the request generation unit 102a determines whether or not there is an unselected data name (step St25). When there is an unselected data name (step St25: Yes), the request generation unit 102a selects the unselected data name in step St21, and performs the processing of step St22 again. Alternatively, when there is no unselected data name (step St25: No), the request generation unit 102a terminates the processing. The transmission processing of the request message is performed in this way.

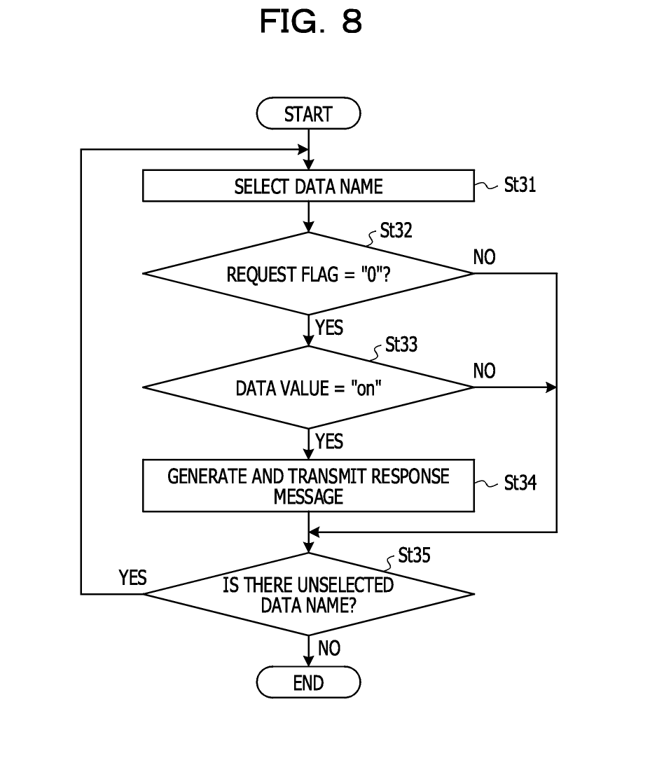

FIG. 8 is a flowchart illustrating an example of transmission processing of a response message including cached data. This processing is performed after the search unit 101 completes setting of request flags for all the data name.

The response unit 105 selects one of the data name in the request management table 130 (step St31). The response unit 105 determines whether or not the request flag is “0” (step St32). When the request flag is “1” (step St32: No), the response unit 105 performs an after-mentioned processing in step St35.

Next, when the request flag is “0” (step St32: Yes), the response unit 105 references variables “value” =“on” in the request management table 130 and determines whether or not data value of the selected data name is “on” (step St33). When the data value is “on” (step St33: Yes), the response unit 105 generates a response message that includes cached data of the selected data name and transmits the response message to the request source device RQ#1 to RQ#5 via the communication ports 14 (step St34). At this time, the cached data included in the response message is acquired by the data acquisition unit 102 and is output to the response unit 105 by the data acquisition unit 102.

In this way, the response unit 105 transmits the cached data acquired from the database 131 by the data acquisition unit 102 to the request source device RQ#1 to RQ#5. At this time, out of searched cached data, the response unit 105 transmits data that satisfies the variable “value”=“on” serving as the restriction condition, to the request source device RQ#1 to RQ#5. Alternatively, when the data value is “off” (step St33: No), the response unit 105 does not perform the processing of step St34.

The processing in step St33 is performed when the request message includes the restriction condition specified by the variable “value”. When no restriction condition is included, the response unit 105 performs the processing of step St34 when the request flag is “0” (step St32: Yes). Note that if the variable “value”=“off”, the processing in step St34 is performed when the data value is “off” and is not performed when the data value is “on”.

Next, the response unit 105 determines whether or not there is an unselected data name (step St35). When there is an unselected data name (step St35: Yes), the response unit 105 selects in step St31 the data name not yet selected and performs the processing of step St32 again. Alternatively, when there is no unselected data name (step St35: No), the response unit 105 terminates the processing. In this way, the transmission processing of the response message including the cached data is performed.

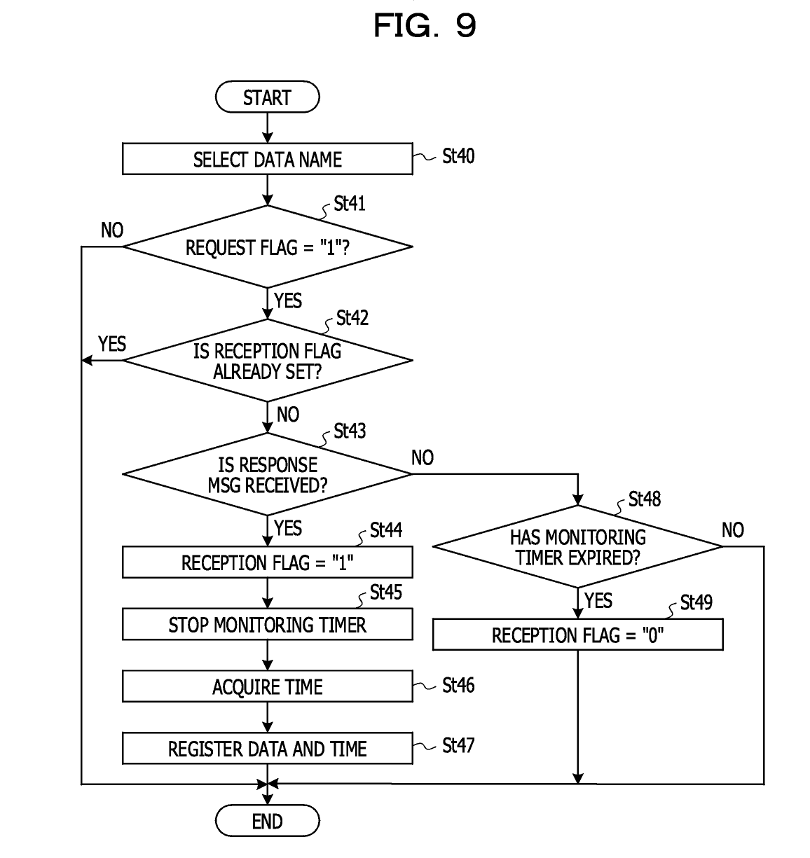

FIG. 9 is a flowchart illustrating an example of reception processing of a response message. This processing is, for example, periodically performed for each of the data name in the request management table 130.

The data reception unit 102b selects one of the data name in the request management table 130 (step St40). At this time, the order of selecting the data name is not limited.

Next, the data reception unit 102b determines whether or not the request flag of the selected data name is “1” (step St41). When the request flag is “0” (step St41: No), the data reception unit 102b terminates the processing.

When the request flag is “1” (step St41: Yes), the data reception unit 102b determines whether or not the reception flag of the selected data name is already set (step St42). With this, the data reception unit 102b determines whether or not receipt of a response message from the data providing device PV#1 to PV#5 has been confirmed for the selected data name.

When the reception flag is already set (step St42: Yes), the data reception unit 102b terminates the processing. On the other hand, when the reception flag is not set (step St42: No), namely, when the reception flags in FIG. 5 is “−”, the data reception unit 102b determines whether or not a response message has been received (step St43).

When the response message is received (step St43: Yes), the data reception unit 102b sets the reception flag to “1” (step St44). Next, the data reception unit 102b stops the monitoring timers 102c (step St45). Next, the data reception unit 102b acquires current time from the timing unit 104 (step St46). Next, the data reception unit 102b registers request target data included in the response message and time (namely, the cached time) in the database 131 (step St47).

In this way, the request target data that satisfies the use condition is cached in the database 131, and the cached time is registered.

On the other hand, in a case in which the response message has not been received (step St43: No), the data reception unit 102b determines whether or not the monitoring timer 102c has expired (step St48). In a case in which the monitoring timer 102c has expired (step St48: Yes), the data reception unit 102b sets the reception flag to “0” (step St49), and in a case in which the monitoring timer 102c has not expired (step St48: No), the data reception unit 102b does not perform the processing of step St49.

In this way, determination as to whether or not the request target data may be provided by the data providing device PV#1 to PV#5 is made with the expiration of the monitoring timer 102c. In this way, the reception processing of the response message is performed.

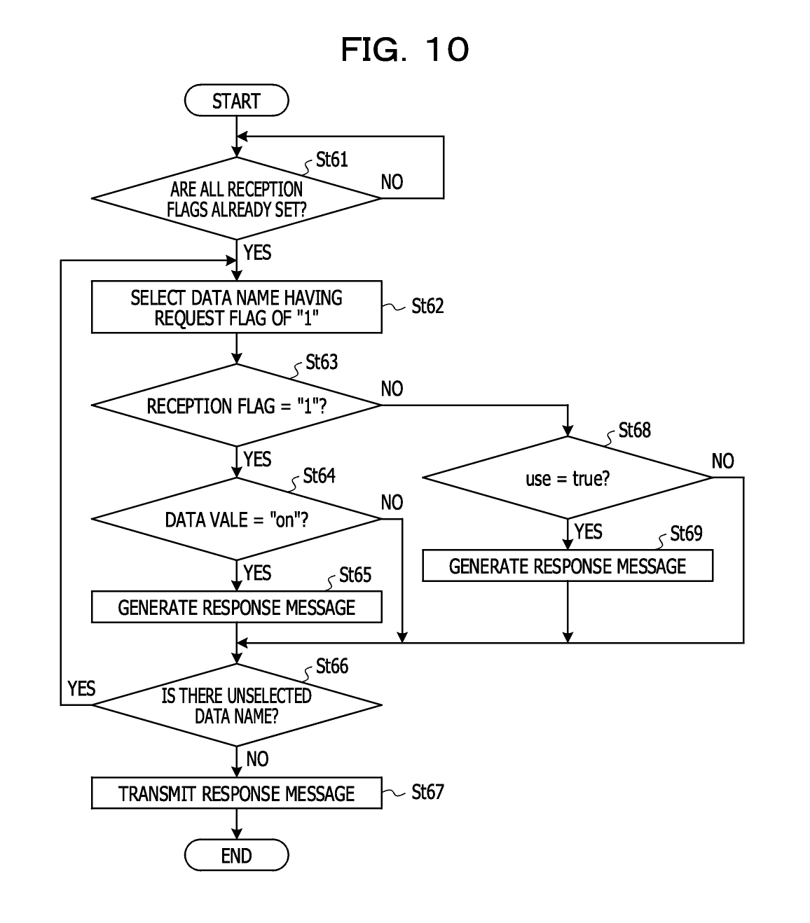

FIG. 10 is a flowchart illustrating an example of transmission processing of a response message including data acquired from the data providing device PV#1 to PV#5. The response unit 105 determines whether or not a reception flag has been set for all data names for which the request flag is “1” (step St61) by monitoring the request management table 130. When a reception flag has not yet been set for all data names (step St61: No), the response unit 105 performs the processing of step St61 again.

In a case in which a reception flag has been set for all data names (step St61: Yes), the response unit 105 selects one out of the data name for which the request flag is “1” (step St62). Next, the response unit 105 determines whether or not the reception flag of the selected data name is “1” (step St63).

When the reception flag is “1” (step St63: Yes), the response unit 105 references variables “value” =“on” in the request management table 130 and determines whether or not the data value of the selected data name is “on” (step St64). Note that, in the same way as the above-mentioned processing of step St33, the processing of step St62 is performed when the request message includes the restriction condition specified by the variable “value”.

When the data value is “on” (step St64: Yes), the response unit 105 generates a response message that includes the cached data of the selected data name (step St65). On the other hand, when the data value is “off” (step St64: No), the response unit 105 does not perform the processing of step St65.

In addition, when the reception flag is “0” (step St63: No), the response unit 105 determines whether or not the variable “use” in the request management table 130 is “true” (step St68). When the variable “use” =“true” (step St68: Yes), the response unit 105 reads from the database 131 cached data that does not satisfy the use condition but matches the name, and the response unit 105 generates a response message including that cached data (step St69). On the other hand, when the variable “use” =“false” (step St68: No), the response unit 105 does not perform the processing of step St69.

The processing of step St68 is performed when the request message includes control information specified by the variable “use”. When no control information is included, the response unit 105 performs the processing of step St66 when the reception flag is “0” (step St63: No).

Next, the response unit 105 determines whether or not there is an unselected data name for which the request flag of “1” (step St66). When there is an unselected data name (step St66: Yes), the response unit 105 selects, in step St62, the data name not yet selected and performs the processing of step St63 again. On the other hand, when there is no unselected data name (step St66: No), the response unit 105 transmits the generated response message to the request source device RQ#1 to RQ#5 via the communication ports 14 (step St67).

In this way, the response unit 105 transmits request target data acquired from the data providing device PV#1 to PV#5 by the data acquisition unit 102, to the request source device RQ#1 to RQ#5. At this time, the response unit 105 transmits, out of the request target data, data that satisfies the restriction condition of the variable “value” =“on”, to the request source device RQ#1 to RQ#5.

In addition, when the data acquisition unit 102 is unable to acquire request target data from the data providing device PV#1 to PV#5, the response unit 105 transmits the cached data matching the name and not satisfying the use condition, to the request source device RQ#1 to RQ#5, based on the variable “use”. In this way, the transmission processing of the response message including data acquired from the data providing device PV#1 to PV#5 is performed.

Next, an example of application of the data providing system of an embodiment will be described.

### FIRST EXAMPLE OF APPLICATION

The data providing system may be applied to various IoT systems. The present example illustrates a case in which a sensor device equipped with a human detection sensor are used as the data providing device PV#1 to PV#5, thereby configuring a sensor system, and the availability of conference room installed with such a sensor device is looked up by a terminal serving as the request source device RQ#1 to RQ#5.

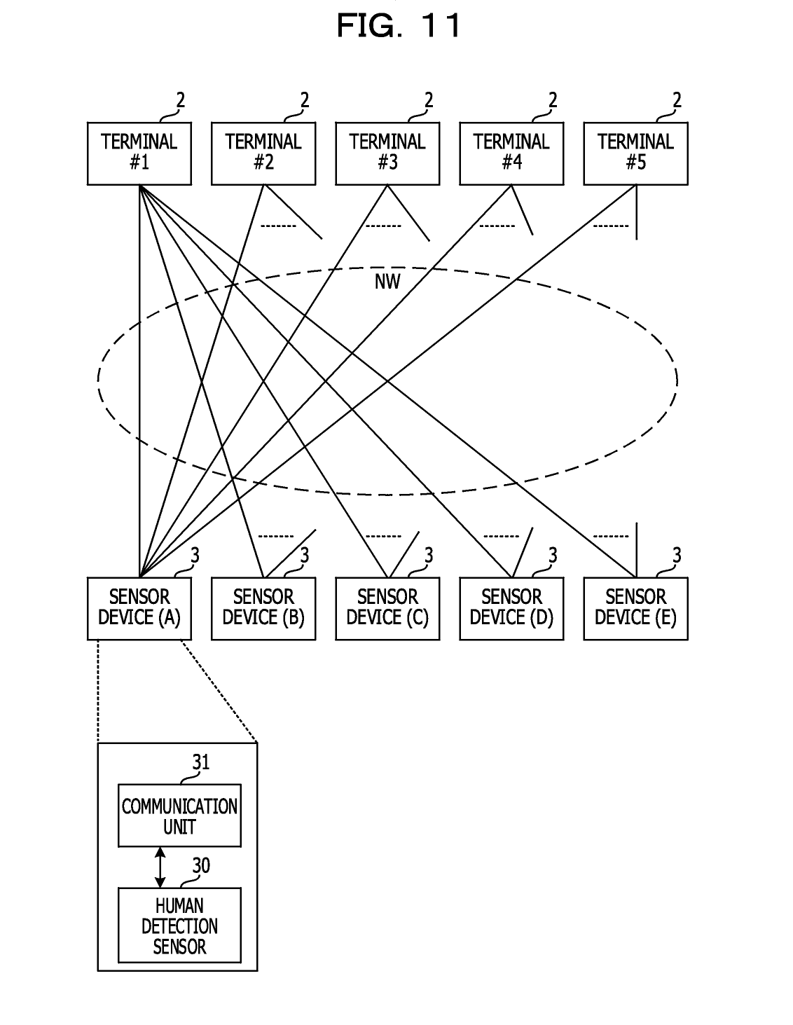

FIG. 11 is a configuration diagram illustrating a comparative example of a sensor system. The sensor system includes multiple terminal 2 (#1 to #5) and multiple sensor device 3, coupled to one another in a mesh shape via a network NW. The terminal 2 functions as the request source device RQ#1 to RQ#5 and the sensor device 3 functions as the data providing device PV#1 to PV#5.

Examples of the terminal 2 (#1 to #5) include smartphones and personal computers, but not limited thereto. Note that in FIG. 11, although only the couplings of the terminal #1 and the sensor device 3 (A) are illustrated, the other terminal #2 to #5 and sensor device 3 (B to E) are also coupled in a similar way.

The sensor device 3 is, for example, disposed in the conference room A to E and senses whether there is someone in the conference room A to E. The sensor device 3 includes a human detection sensor 30 for sensing a human and a communication unit 31 for processing communication with the terminal #1 to #5. Note that examples of the communication unit 31 include a LAN card, but not limited thereto.

Based on sensing results of the human detection sensors 30, the sensor device 3 determines the availability of conference room A to E and generates data indicating the determination result. The data indicates “on” when the conference room A to E is occupied, and the data indicates “off” when the conference room A to E is vacant. An application for confirming the availability of the conference room A to E is installed in the terminal 2, and the terminal 2 requests data from the sensor device 3 using the application.

Each of the terminal 2 individually requests data from the sensor device 3. Therefore, sharing of data received from the sensor device 3 among each of the terminal 2 is not performed. Accordingly, traffic in the network NW may not be reduced.

Thus, applying ICN to this sensor system enables traffic in the network NW to be reduced, since application of ICN enables data to be cached in relay devices within the network NW.

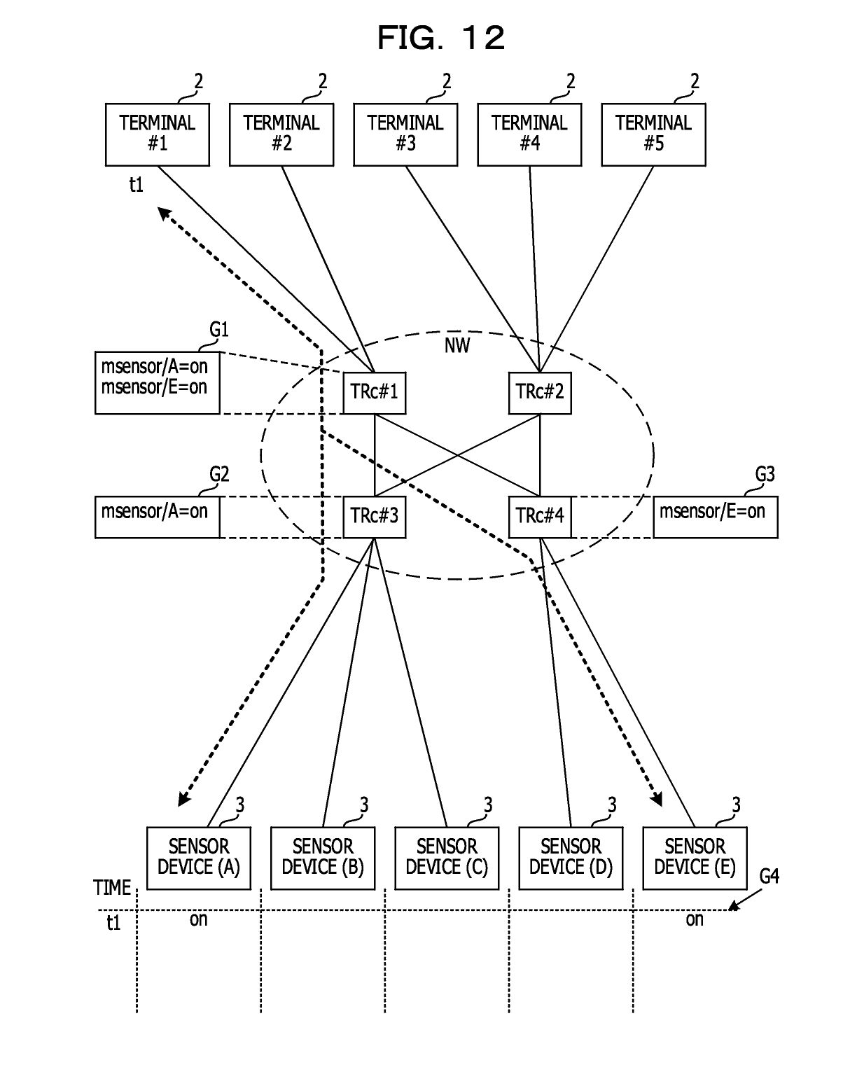

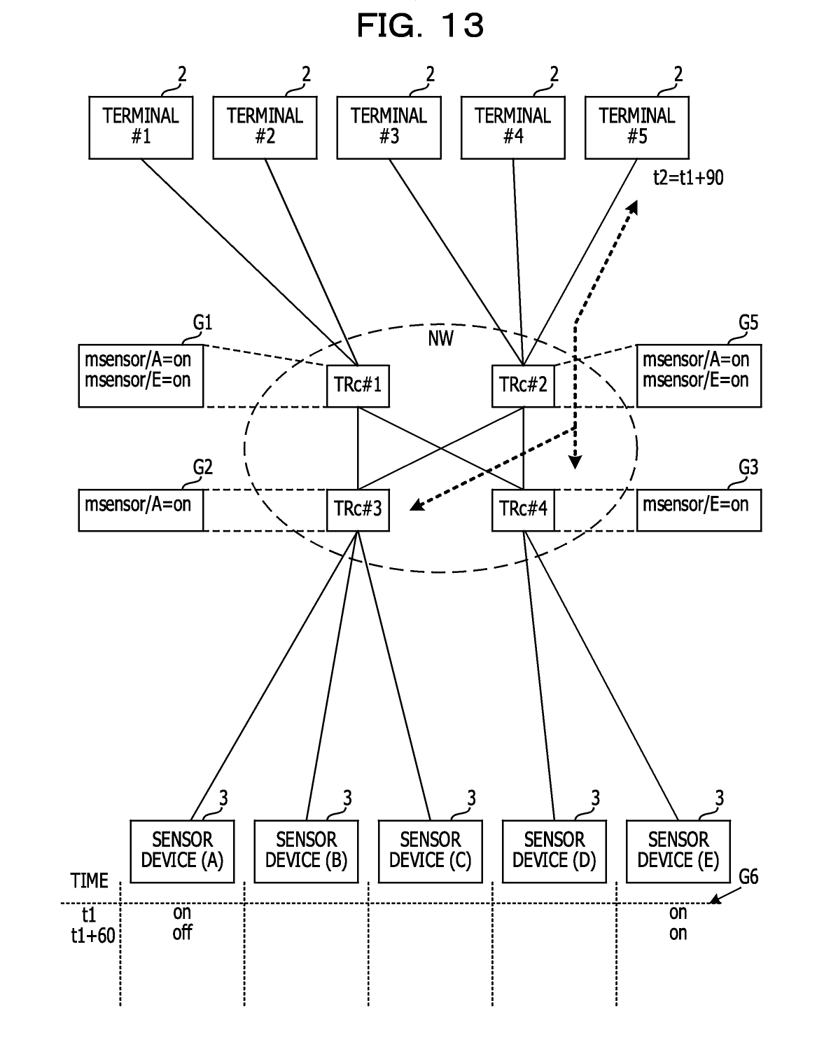

FIG. 12 and FIG. 13 are configuration diagrams each illustrating another comparative example of the sensor system. In each of FIG. 12 and FIG. 13, configurations common to those in FIG. 11 are assigned the same symbols, and the descriptions thereof are omitted.

In the present example, a relay device TRc#1 to TRc#4 according to the comparative example is provided in the network NW. The relay devices TRc#1 through TRc#4 are coupled to one another in a mesh shape. The relay device TRc#1 is coupled to the terminal 2 (#1 and #2), and the relay device TRc#2 is coupled to the terminal 2 (#3 to #5). In addition, the relay device TRc#3 is coupled to the sensor device 3 in the conference room A to C, and the relay device TRc#4 is coupled to the sensor device 3 in the conference rooms D and E.

The terminal 2, the sensor device 3, and the relay device TRc#1 to TRc#4 perform communication based on the ICN. The relay device TRc#1 to TRc#4 relays request messages from the terminal 2 to the sensor device 3 and relays response messages from the sensor device 3 to the terminal 2. The relay device TRc#1 to TRc#4 each caches data that is included in the relayed response messages, and when a new request message is received from the terminal 2, the relay device TRc#1 to TRc#4 transmits such cached data included in a response message to the terminal 2.

As illustrated in FIG. 12, at time t1, the terminal 2 (#1) acquires data from each sensor device 3 in the conference room A and E, following paths indicated by dotted lines. Here, it is assumed that data from the sensor device 3 in the conference room A is specified by a name “msensor/A” and data from the sensor device 3 in the conference room E is specified by a name “msensor/E”.

Symbol G4 indicates data value of data from the sensor device 3 at each point of time. At time t1, data from the sensor device 3 in the conference rooms A and E indicates “on” (occupied).

The relay devices TRc#1 and TRc#3 relay data “msensor/A” from the sensor device 3 in the conference room A to the terminal 2 (#1). In addition, the relay devices TRc#1 and TRc#4 relay data “msensor/E” from the sensor device 3 in the conference room E to the terminal 2 (#1).

Therefore, as indicated by symbol G1, data having the data name “msensor/A” and the data value “on”, and data having the data name “msensor/E” and the data value “on” are cached in the relay device TRc#1. In addition, as indicated by symbol G2, data having the data name “msensor/A” and the data value “on” are cached in the relay device TRc#3. As indicated by symbol G3, data having the data name “msensor/E” and the data value “on” are cached in the relay device TRc#4.

Next, as illustrated in FIG. 13, the terminal 2 (#5) requests data from the sensor device 3 in the conference rooms A and E at time t2 (=t1+90 (sec)). At this time, the data from the sensor device 3 in the conference room A is cached in the relay device TRc#3 located on a path from the terminal 2 (#5) to the sensor device 3 in the conference room A, as indicated by the symbol G2. In addition, the data from the sensor device 3 in the conference room E is cached in the relay device TRc#4 located on a path from the terminal 2 (#5) to the sensor device 3 in the conference room E, as indicated by the symbol G3.

Therefore, the terminal 2 (#5) acquires data from the relay device TRc#3 and TRc#4 following the paths indicated by dotted lines, rather than from the respective sensor device 3 in the conference rooms A and E. At this time, the relay device TRc#2 relays the data “msensor/A” and the data “msensor/E”, from the relay device TRc#3 and TRc#4 to the terminal 2 (#5). As a result, as indicated by symbol G5, the data having the data name “msensor/A” and the data value “on” and the data having the data name “msensor/E” and the data value “on” are cached in the relay device TRc#2.

In this way, the terminal 2 (#5) acquires the data having the data name “msensor/A” and the data value “on” and the data having the data name “msensor/E” and the data value “on”. Thus, a user of the terminal 2 (#5) recognizes that both the conference rooms A and E are occupied.

However, as indicated by symbol G6 at time (t1 +60 (sec)), if it is assumed that, the data from the sensor device 3 in the conference room E remains “on” (occupied) but the data from the sensor device 3 in the conference room A has become “off” (vacant), the user is lead to erroneously recognize the availability of the conference room, by the use of the old cached data.

Therefore, according to the present example, while it is possible to reduce traffic in the network NW with the cached data of the relay devices TRc#1 through TRc#4, there are cases in which the sensor system does not function effectively depending on time at which cached data is cached, due to a highly real-time nature of the data.

In contrast, as described above, the relay device TR#1 to TR#4 of an embodiment not only caches data in the database 131 but also registers cached time of the data. This enables the relay device TR#1 to TR#4 to search for the cached data that satisfies a use condition specified by a request message, and to transmit the cached data.

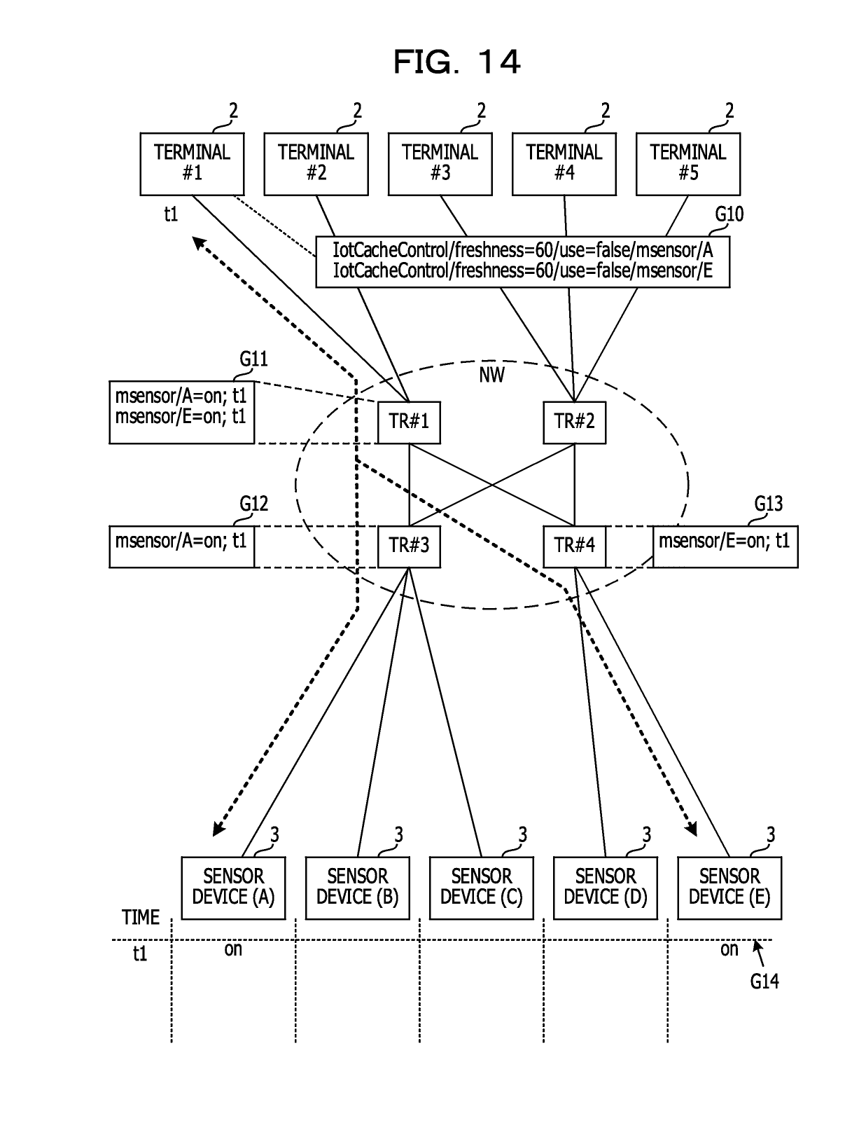

FIG. 14 to FIG. 16 are configuration diagrams illustrating an embodiment of a sensor system. In each of FIG. 14 to FIG. 16, configurations common to those in FIG. 11 are assigned the same symbols, and the descriptions thereof are omitted.

In the present example, the relay device TR#1 to TR#4 according to an embodiment are coupled in a mesh shape within the network NW. The relay device TRc#1 is coupled to the terminal 2 (#1 and #2), and the relay device TRc#2 is coupled to the terminal 2 (#3 to #5). In addition, the relay device TRc#3 is coupled to the respective sensor device 3 in the conference room A to C, and the relay device TRc#4 is coupled to the respective sensor device 3 in the conference rooms D and E.

FIG. 14 illustrates an example of operation when, at time t1, the terminal 2 (#1) transmits two request messages indicated by symbol G10. The request message for requesting data from the sensor device 3 in the conference room A includes the function ID “IotCacheControl”, the use condition “freshness=60 (sec)”, the processing information “use=false”, and the name “msensor/A”. The request message to request data from the sensor device 3 in the conference room E includes the name “msensor/E”, with the rest of the items same as the above.

At time t1, data from the sensor device 3 has not been cached in the database 131 of the respective relay device TR#1 to TR#4. Therefore, the request messages are relayed to the respective sensor device 3 in the conference rooms A and E, following the paths indicated by dotted lines.

The sensor device 3 transmits a response message in which data is contained in response to a request message. As indicated by symbol G14, at time t1, data for the respective sensor device 3 in the conference room A and E indicates “on”. The response message travels the path of the request message backwards and are relayed to the terminal 2 (#1).

Therefore, the relay device TR#1 and TR#3 relay, the data “msensor/A” from the sensor device 3 in the conference room A to the terminal 2 (#1). In addition, the relay device TR#1 and TR#4 relay the data “msensor/E” from the sensor device 3 in the conference room E to the terminal 2 (#1).

Therefore, as indicated by symbol G11, the relay device TR#1 caches data having the data name “msensor/A” and the data value “on” and data having the data name “msensor/E” and the data value “on” in the database 131. The relay device TR#1 further registers the cached time t1 of the respective data in the database 131.

In addition, as indicated by symbol G12, the relay device TR#3 caches the data having the data name “msensor/A” and the data value “on” in the database 131. The relay device TR#3 further registers the cached time t1 of the data in the database 131.

In addition, as indicated by symbol G13, the relay device TR#4 caches the data having the data name “msensor/E” and the data value “on” in the database 131. The relay device TR#4 further registers the cached time t1 of the data in the database 131.

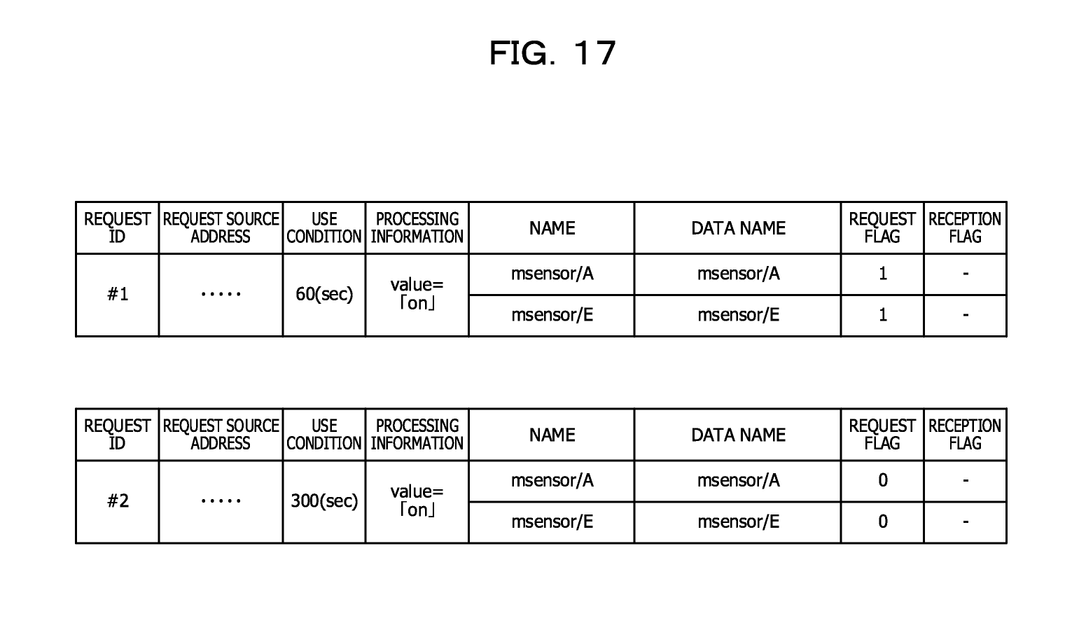

FIG. 17 illustrates an example of the request management table 130 for the relay device TR#1 at time t1. At time t1, there is no cached data matching the name “msensor/A” or “msensor/E” specified by the request messages. Thus, the relay device TR#1 registers “msensor/A” and “msensor/E” as data name in the request management table 130 and sets the request flag to “1”. The relay device TR#1 thereby transmits request messages to the respective sensor devices 3 in the conference rooms A and E.

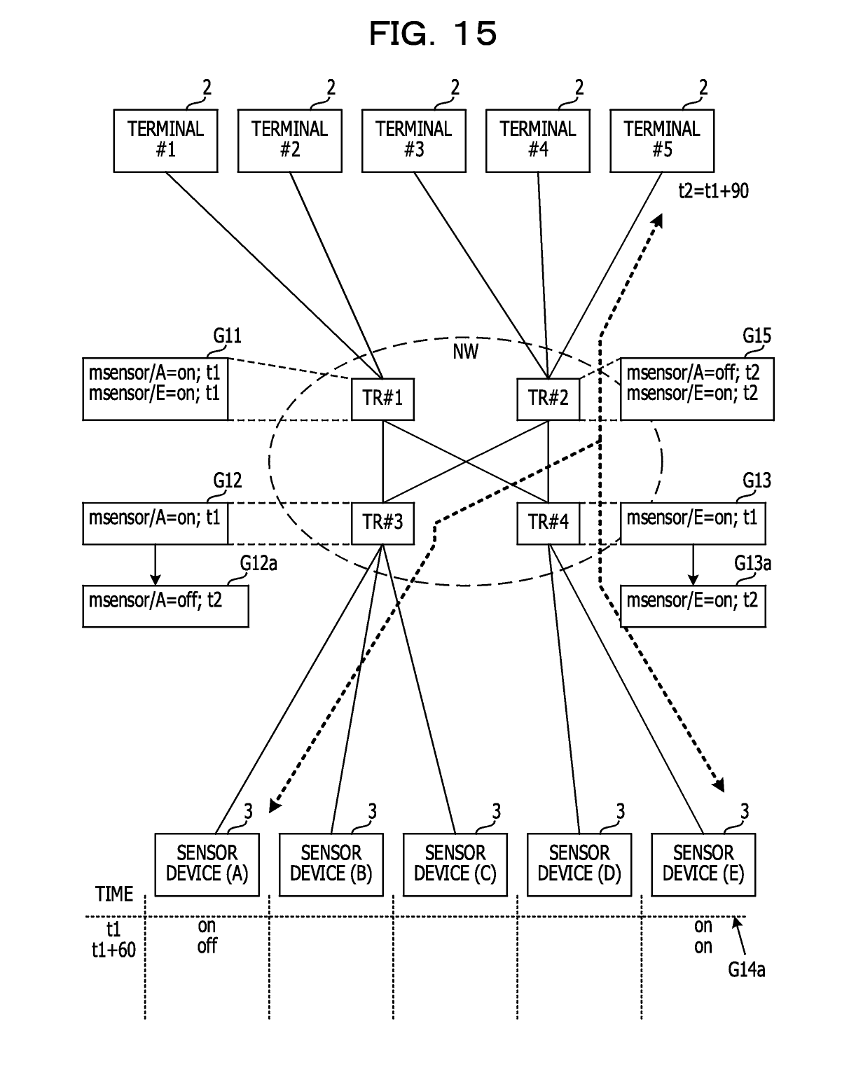

FIG. 15 illustrates an example of operation when, at time t2 (=t1+90 (sec)), the terminal 2 (#5) transmits request messages for requesting data for the respective sensor device 3 in the conference rooms A and E. Note that dotted lines indicate paths of the request messages and response messages.

In the same way as in the case of FIG. 14, the use condition of “freshness=60 (sec)” and the name “msensor/A” are specified in one of the request messages, and the use condition of “freshness=60 (sec)” and the name “msensor/E” are specified in the other request message. Since there is no cached data in the database 131, the relay device TR#2 transmits the request message having the name “msensor/A” to the relay device TR#3, and transmits the request message having the name “msensor/E” to the relay device TR#4.

In the relay device TR#3, the cached data having the data name “msensor/A” has been cached in the database 131, as indicated by the symbol G12. However, since the cached time of the cached data is t1, the cached data does not satisfy “freshness=60 (sec)” serving as the use condition of the request messages.

This use condition of “freshness=60 (sec)” specifies that the range of the cached time of cached data is from 60 (sec) before the current time t2 through the current time t2. Since the cached time t1 is 90 (sec) before the current time t2, this falls outside the range specified by the use condition.

Accordingly, the relay device TR#3 may not transmit the cached data having the cached time t1 to the terminal 2 (#5). Therefore, the relay device TR#3 acquires data at time t2 from the sensor device 3 in the conference room A, by transmitting the request message to the sensor device 3 in the conference room A.

The sensor device 3 in the conference room A transmits a response message that contains data in response to the request message. As indicated by symbol G14a, data from the sensor device 3 in the conference room A indicates “off” (vacant) at time (t1+60 (sec)). The response message travels the path of the request messages backwards from the relay device TR#3 and is relayed to the terminal 2 (#5).

At this time, as indicated by symbol G12a, the relay device TR#3 caches data having the data name “msensor/A” and the data value “off” in the database 131, and registers the cached time t2. The cached data and the cached time of the relay device TR#3 are thereby updated.

As for the relay device TR#4, as indicated by the symbol G13, the cached data having the data name “msensor/E” has been cached in the database 131. However, since the cached time of the cached data is t1, the cached data does not satisfy “freshness=60 (sec)” serving as the use condition of the request messages.

Accordingly, the relay device TR#4 may not transmit the cached data having the cached time t1 to the terminal 2 (#5). Therefore, the relay device TR#4 acquires data at time t2 from the sensor device 3 in the conference room E by transmitting the request message to the sensor device 3 in the conference room E.

In response to the request message, the sensor device 3 in the conference room E transmits a response message that contains data. As indicated by the symbol G14a, at time (t1+60 (sec)), data from the sensor device 3 in the conference room E indicates “on” (occupied). The response message travels the path of the request messages backwards from the relay device TR#4 and is relayed to the terminal 2 (#5).

At this time, as indicated by symbol G13a, the relay device TR#4 caches, data having the data name “msensor/E” and the data value “on” in the database 131, and registers the cached time t2. The cached data and the cached time of the relay device TR#4 are thereby updated.

In addition, the relay device TR#2 transmits the respective response messages transmitted by the relay devices TR#3 and TR#4 to the terminal 2 (#5). At this time, as indicated by symbol G15, the relay device TR#2 caches the data having the data name “msensor/A” and the data value “off” and the data having the data name “msensor/E” and the data value “on” and registers the cached time t2 in the database 131.

In this way, the relay device TR#2 to TR#4 acquires the data from the respective sensor devices 3 in the conference rooms A and E at time t2, in accordance with the use condition “freshness=60 (sec)” specified by the request message, and transmits the data to the terminal 2 (#5). Unlike the comparative example of FIG. 13, this enables a user of the terminal 2 (#5) to accurately know the availability of the conference rooms A and E at the current time t2 rather than the old time t1.

According to the present example, the relay device TR#1 to TR#4 is enabled to effectively provide data of a highly real-time nature to the terminal 2 in accordance with the use condition, thereby enabling the sensor system to function effectively.

In addition, even when cached time of the data is old, such data may be used as effective data depending on the use conditions.

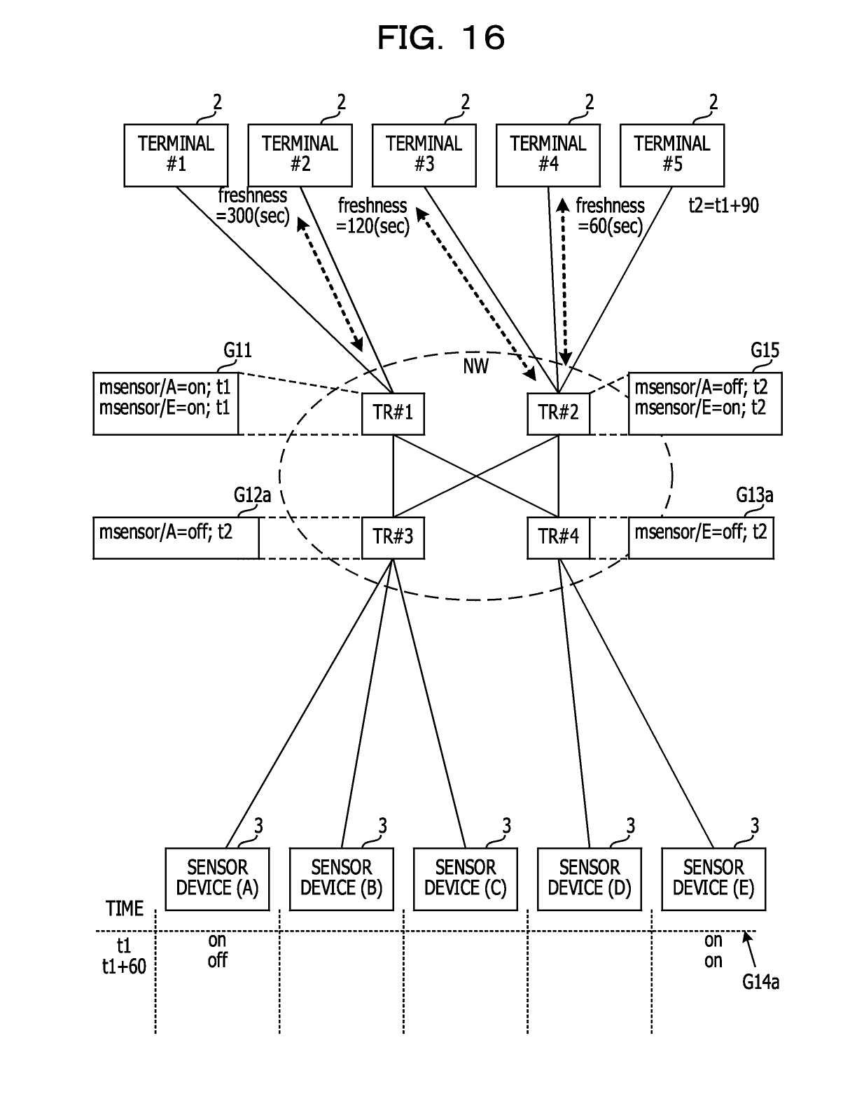

FIG. 16 illustrates an example of operation when the terminal 2 (#2 to #4) requests data from the sensor devices 3 in the conference room A and E by specifying use conditions different from one another immediately after the operation illustrated in FIG. 15. The terminal 2 (#3) transmits a request message in which the use condition “freshness=120 (sec)” is specified to the relay device TR#2, and the terminal 2 (#4) transmits a request message in which the use condition “freshness=60 (sec)” is specified to the relay device TR#2.

As indicated by the symbol G15, the cached data having the respective data name “msensor/A” and “msensor/E” is cached in the database 131 in the relay device TR#2, and the cached time is t2. Accordingly, since the cached data of the relay device TR#2 satisfies the use condition, the relay device TR#2 transmits a response message including the cached data to the respective terminal 2 (#4) and terminal 2 (#5).

In addition, the terminal 2 (#2) transmits a request message in which the use condition “freshness=300 (sec)” is specified to the relay device TR#1. As indicated by the symbol G11, the cached data having the data names “msensor/A” and “msensor/E” is cached in the database 131 in the relay device TR#1, and the cached time is t1.

The use condition of “freshness=300 (sec)” specifies the range of a cached time of cached data as a period of time from 300 (sec) before the current time t2 through the current time t2. Since the cached time t1 is 90 (sec) before the current time t2, the cached time t1 falls within the range specified by the use condition.

Accordingly, since the cached data of the relay device TR#1 satisfies the use condition, the relay device TR#1 transmits a response message that includes the cached data to the terminal 2 (#2).

FIG. 17 illustrates an example of the request management table 130 for the relay device TR#2 at time t2 in the sensor system. At time t2, the cached data that matches the names “msensor/A” and “msensor/E” specified by the request messages and that satisfies the use condition is cached in the database 131 in the relay device TR#1.

Therefore, the relay device TR#1 registers “msensor/A” and “msensor/E” as the data name in the request management table 130 and sets the request flags thereof to “0”. With this, the relay device TR#1 transmits no request messages to the respective sensor devices 3 in the conference rooms A and E.

In this way, depending on cache conditions specified by request messages, the relay device TR#1 to TR#4 generates and transmits response messages that includes cached data to the terminal 2 (#1 to #5). Therefore, according to the present example, this enables the relay device TR#1 to TR#4 to omit processing for relaying request messages to the sensor device 3 and processing performed by the sensor device 3 for transmitting response messages, thereby enabling traffic in the network NW to be reduced.

In addition, as illustrated in the following example, by specifying a restriction condition of data by the variable “value” as processing information of a request message, data transmitted by the relay device TR#1 to TR#4 may be restricted, and traffic in the network NW may be further reduced.

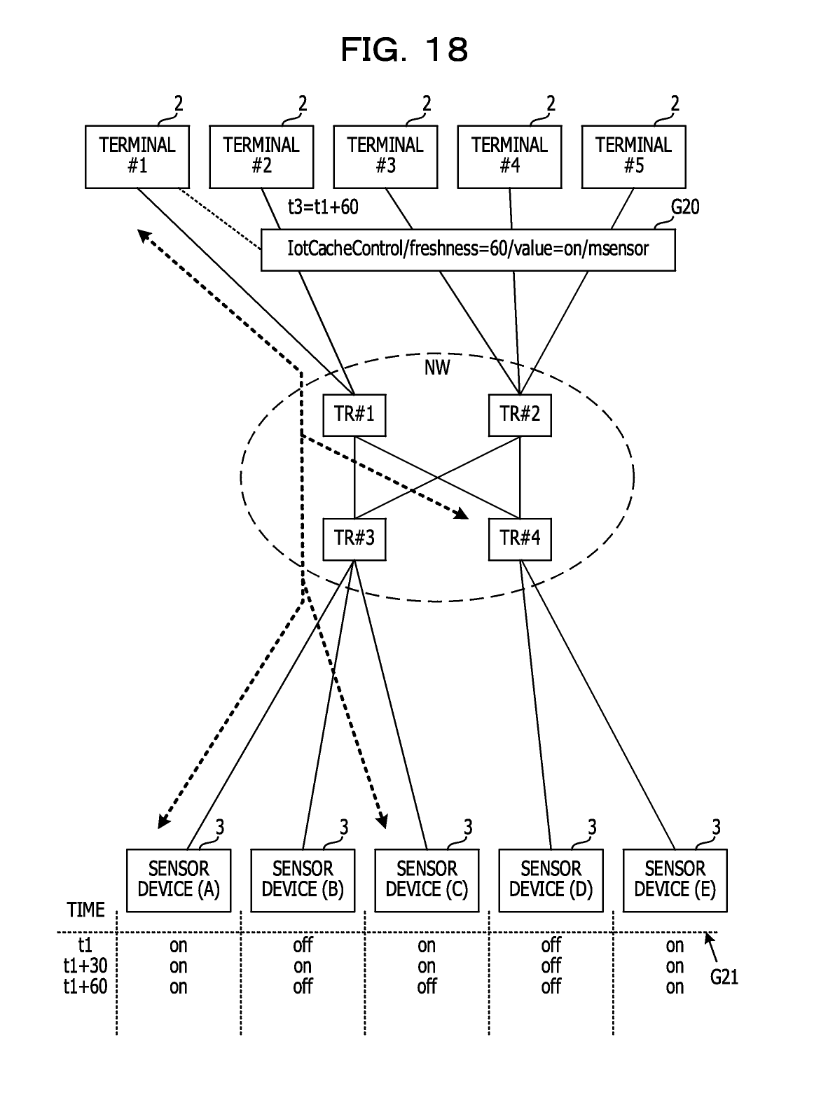

FIG. 18 is a configuration diagram illustrating an embodiment of the sensor system. At time t3 (=t1+60 (sec)), the terminal 2 (#1) transmits a request message indicated by symbol G20. Note that paths of the request messages and response messages are indicated by dotted lines.

The request message includes the function ID “IotCacheControl”, the use condition “freshness=60 (sec)”, the processing information “value=on”, and the name “msensor”. According to this request message, as the name “msensor” is specified using a prefix, data from each of the sensor devices 3 in the conference rooms A through E is requested. However, the data is restricted by the processing information “value=on”, and only the data having the data value “on” is acquired. In addition, cached time of cached data acquirable from the relay device TR#1 to TR#4 is within the range from 60 (sec) before the current time t3 to the current time t3, based on the use condition.

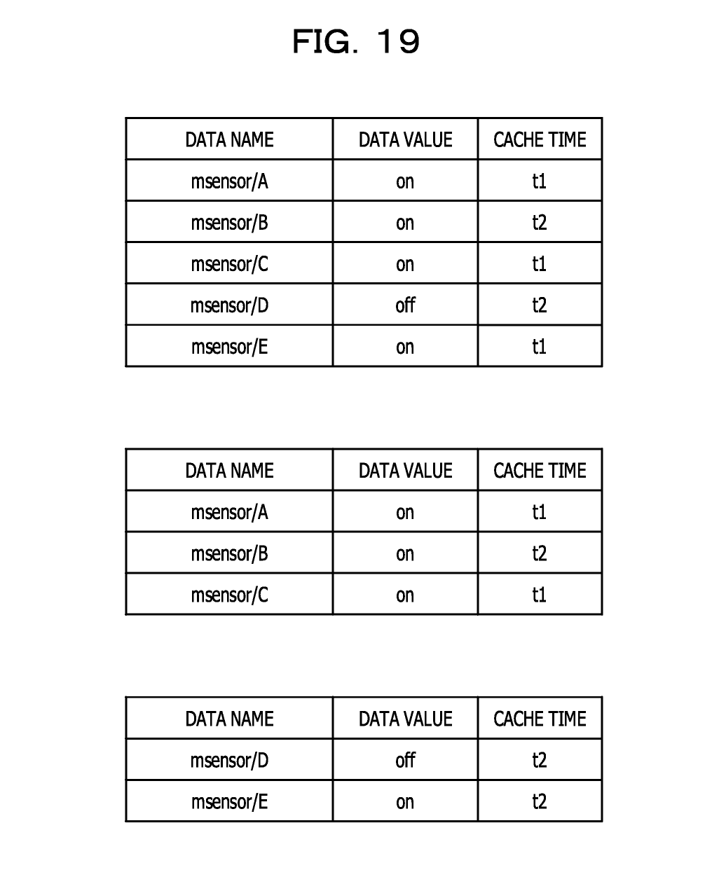

FIG. 19 illustrates the databases 131 for the relay devices TR#1, TR#3, and TR#4 at time t3. In the database 131 in the relay device TR#1, cached data having the data names “msensor/A” through “msensor/E” is registered. Out of the data names “msensor/A” through “msensor/E”, only the data value of “msensor/D” is “off”, and the other data values are “on”. In addition, out of the data names “msensor/A” through “msensor/E”, the respective cached time of “msensor/B” and “msensor/D” is t2 (t1+30 (sec)), and the other cached time is t1.

In addition, in the database 131 in the relay device TR#3, the cached data having the data names “msensor/A” through “msensor/C” is registered, and the data values thereof are all “on”. The cached time of “msensor/A” and “msensor/C” is t1 respectively, and the cached time of “msensor/B” is t2.

In addition, in the database 131 in the relay device TR#4, the cached data having the data names “msensor/D” and “msensor/E” respectively is registered, and the cached time thereof are all “t2”. The data value of “msensor/D” is “off”, and the data value of “msensor/E” is “on”.

Referencing FIG. 18 again, out of the cached data of the relay device TR#1, the cached time t2 of the cached data for “msensor/B” and “msensor/D” satisfies the use condition, however, as the data value of “msensor/D” is “off”, its transmission is restricted by the processing information “value=on”. Therefore, the relay device TR#1 generates and transmits a response message including the cached data of “msensor/B” to the terminal 2 (#1).

In addition, the relay device TR#1 generates request messages respectively for “msensor/A”, “msensor/C”, and “msensor/E” for which the use condition is not satisfied. The request messages for “msensor/A” and “msensor/C” respectively are transmitted to the relay device TR#3, and the request message for “msensor/E” is transmitted to the relay device TR#4.

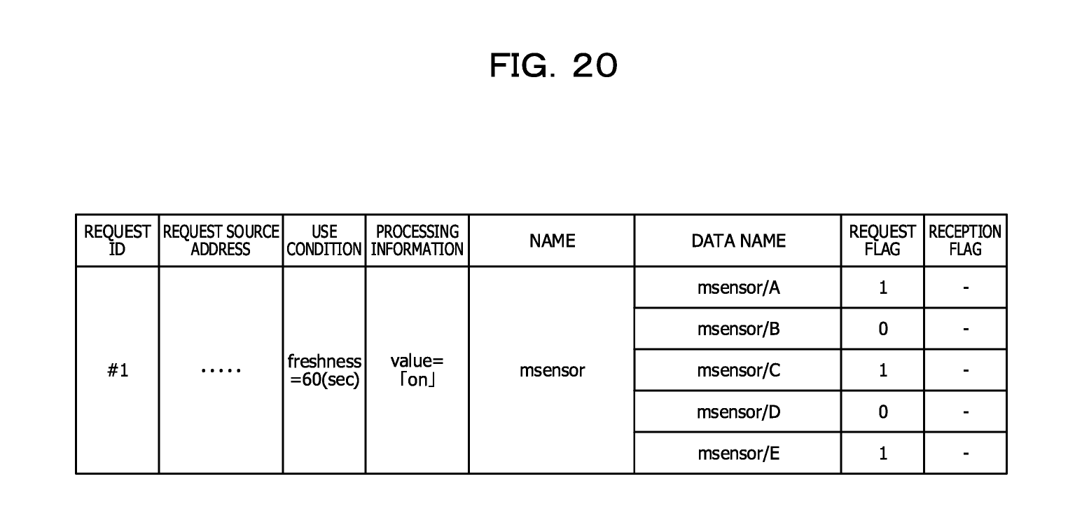

FIG. 20 illustrates the request management table 130 in the relay device TR#1 at time t3. In the request management table 130, “freshness=60 (sec)” is registered as the use condition, and “value=on” is registered as the processing information. In addition, out of the data names “msensor/A” through “msensor/E”, the request flags respectively for “msensor/A”, “msensor/C”, and “msensor/E” are set to “1”.

Therefore, request messages in which the request target data is specified respectively by the name “msensor/A”, “msensor/C”, and “msensor/E” are generated and transmitted. Note that since the request flag is set to “0” respectively for “msensor/B” and “msensor/D”, request messages for the name “msensor/B” and “msensor/D” are generated.

Referencing FIG. 18 again, in the database 131 in the relay device TR#3, the respective cached data having data names matching “msensor/A” and “msensor/C” is registered. However, as the cached time of the respective cached data is “t1”, the use condition of the request messages is not satisfied. Therefore, the relay device TR#3 transmits a request message having the name “msensor/A” to the sensor device 3 in the conference room A, and transmits a request message having the name “msensor/C” to the sensor device 3 in the conference room C.

In response to the request messages, the sensor device 3 in the conference room A transmits a response message that contains data. As indicated by symbol G21, at time (t1 +60 (sec)), data from the sensor device 3 in the conference room A indicates “on” (occupied). The response message travels the path of the request messages backwards from the relay device TR#3 and is relayed to the terminal 2 (#1).

In response to the request messages, the sensor device 3 in the conference room A transmits the response message that contains data. As indicated by the symbol G21, at time (t1+60 (sec)), data from the sensor device 3 in the conference room A indicates “on” (occupied). The response message is transmitted to the relay device TR#3.

On the other hand, the sensor device 3 in the conference room C transmits a response message that contains data in response to the request messages. As indicated by the symbol G21, at time (t1+60 (sec)), data from the sensor device 3 in the conference room C indicates “off” (vacant). The response message is transmitted to the relay device TR#3.

The relay device TR#3 receives response messages from the respective sensor devices 3 in the respective conference rooms A and C. As the data value of the data name “msensor/C” is “off”, the relay device TR#3 stops transmission based on the processing information “value=on”. Accordingly, the relay device TR#3 transmits only a response message including data having the data name “msensor/A” to the relay device TR#1.

In addition, in the database 131 in the relay device TR#4, the respective cached data having data names matching “msensor/D” and “msensor/E” are registered. As the respective cached time of the cached data is t2, the use condition of the request message is satisfied. However, since the data value of the data name “msensor/D” is “off”, transmission thereof is restricted by the processing information “value=on”. Accordingly, the relay device TR#4 transmits only the response message including cached data having the data name “msensor/E” to the relay device TR#1.

The relay device TR#1 receives the response message including the data having the data name “msensor/A” from the relay device TR#3, and receives the response message including the cached data having the data name “msensor/E” from the relay device TR#4. The relay device TR#1 transmits the received response messages to the terminal 2 (#1).

This thereby results in the terminal 2 (#1) acquiring only the data having the data name “msensor/A”, “msensor/B”, and “msensor/E” for which data value is “on” (occupied) due to a restriction condition specified by the processing information “value=on”, despite requesting data from the sensor devices 3 in all conference rooms A to E. Accordingly, traffic in the network NW is reduced.

In addition, the relay devices TR#1 and TR#3 each update the cached data and the cached time of the database 131 at the time of relaying the response messages.

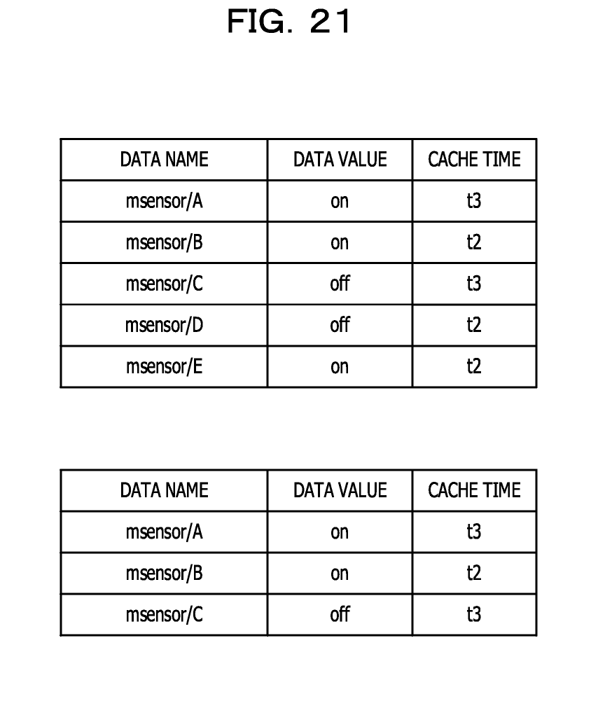

FIG. 21 illustrates the databases 131 for the respective relay devices TR#1 and TR#3 after the updating. In the relay device TR#1, the data values and the cached time of the cached data having the respective data names “msensor/A”, “msensor/C”, and “msensor/E” have been updated. In the relay device TR#3, the data values and the cached time of the cached data having the respective data names “msensor/A” and “msensor/C” have been updated.

### SECOND EXAMPLE OF APPLICATION

The data providing system of an embodiment may be applied to, for example, an inter-enterprise collaboration system for exchanging traffic congestion information. Description follows regarding a traffic information system utilizing telematics as an example. Note that telematics is a service provided to, for example, automobiles, transportation vehicles, and so forth, using a mobile communication system.

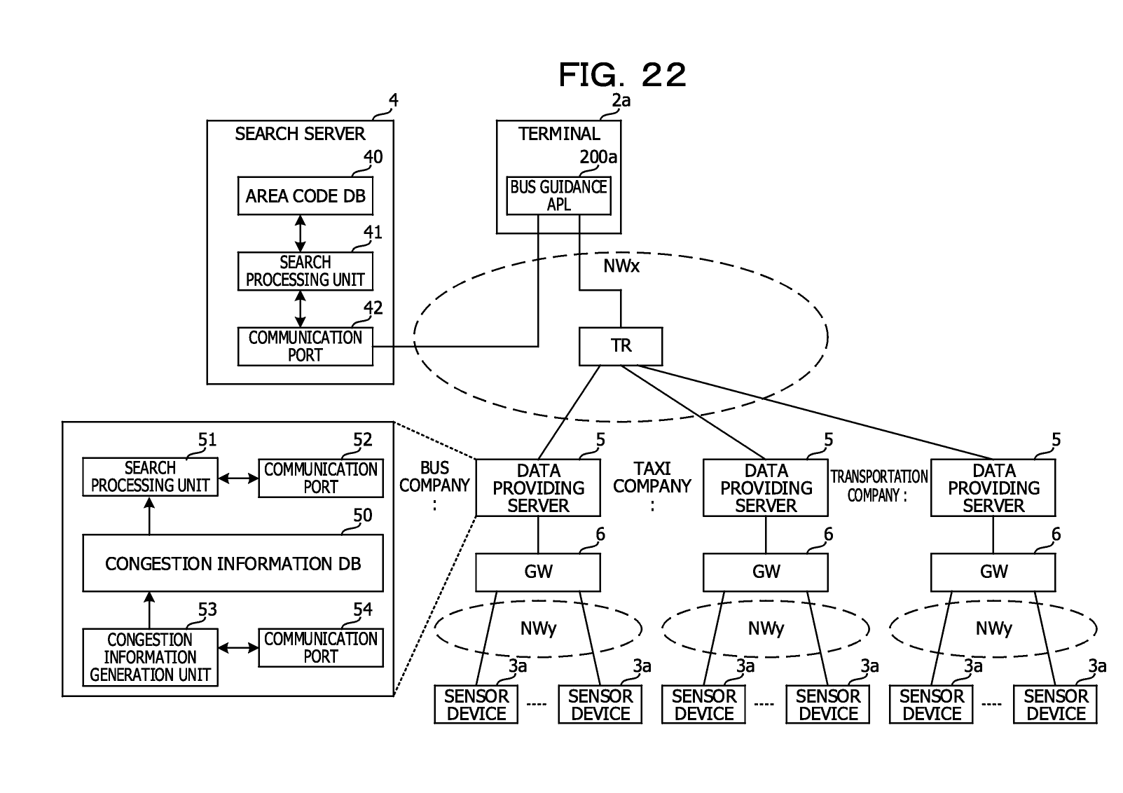

FIG. 22 is a configuration diagram illustrating an embodiment of the traffic information system. The traffic information system includes a terminal 2a such as a smartphone or a personal computer, a search server 4 that searches for area codes, a relay device TR serving as an example of an information processing apparatus, multiple data providing servers 5 that provide congestion information, multiple sensor devices 3a, and multiple gateway device (GW) 6.

The data providing servers 5 are examples of the data providing device PV#1 to PV#5 and provide congestion information to the terminal 2a. A bus guidance application 200a is installed in the terminal 2a, as an example of the application 200. The bus guidance application 200a acquires congestion information from the data providing servers 5, and based on the congestion information searches for and notify a user a bus first to arrive at a bus stop at the current location.

Each data providing server 5 performs communication with the multiple sensor device 3a via the gateway device 6. The gateway device 6 is, for example, a wireless access point and performs a wireless communication with the sensor device 3a via a network NWy. The sensor device 3a is mounted in a vehicle, and detects and transmits location information and traffic information to the data providing server 5.

The data providing server 5 is, for example, installed at each company such as a bus company, a taxi company, and a transportation company. The data providing servers 5 of each company forms a horizontally integrated inter-enterprise collaboration system.

The data providing server 5 includes a congestion information database (congestion information DB) 50, a search processing unit 51, a congestion information generation unit 53, and communication ports 52 and 54. The data providing server 5 is configured by the CPU, the ROM, the RAM, the storage device, and so forth, as illustrated in FIG. 2 and FIG. 3.

The search processing unit 51 and the congestion information generation unit 53 are formed as functions of the CPU by a predetermined program. In addition, the congestion information database 50 is stored in the storage device. The communication port 54 processes communication with the sensor device 3a, and the communication port 52 processes communication with the relay device TR.

The congestion information generation unit 53 collects traffic information and location information from the plural sensor devices 3a via the communication port 54. The congestion information generation unit 53 generates congestion information based on the traffic information and the location information, and registers the congestion information in the congestion information database 50. The congestion information indicates a numerical value indicating the degree of congestion and is registered in association with area codes based on the location information indicating locations of a vehicle.

The search processing unit 51 acquires an area code from the relay device TR via the communication port 52 and searches the congestion information database 50 for congestion information according to the area code. The search processing unit 51 transmits the searched congestion information to the relay device TR via the communication port 52.

The terminal 2a is an example of the request source device RQ#1 to RQ#5. In accordance with operation of a user, the bus guidance application 200a searches for a bus first to arrive at a bus stop. The bus guidance application 200a searches the search server 4 for area codes on a bus route of a bus stopping at a bus stop where the user is currently located.

The search server 4 includes an area code database (area code DB) 40, a search processing unit 41, and a communication port 42. The search server 4 is configured by the CPU, the ROM, the RAM, the storage device, and so forth, as illustrated in FIG. 2 and FIG. 3.

The search processing unit 41 is formed as a function of the CPU by a predetermined program. In addition, the area code database 40 is stored in the storage device. The communication port 42 processes communication with the terminal 2a.

Upon receiving a request for an area code from the bus guidance application 200a via the communication port 42, the search processing unit 41 searches the area code database 40 for the area code according to the request. Note that the request for the area code includes, for example, a route number of a bus and so forth.

The search processing unit 41 transmits the searched area code to the terminal 2a. The bus guidance application 200a generates a request message in which the area code is specified as a name, and transmits the request message to the relay device TR within a network NWx. When cached data that corresponds to the area code and satisfies a use condition is cached in the database 131, the relay device TR generates and transmits a response message that includes the cached data to the terminal 2a.

In addition, when no cached data that corresponds to the area code and satisfies the use condition is cached in the database 131, the relay device TR generates and transmits a request message to the data providing servers 5. The data providing servers 5 generates a response message including congestion information that corresponds to the area code and satisfies the use condition, and transmits the response message to the relay device TR. The relay device TR receives the response message, caches the congestion information, and transmits the response message to the terminal 2a. Description of an example of operation of the traffic information system follows.

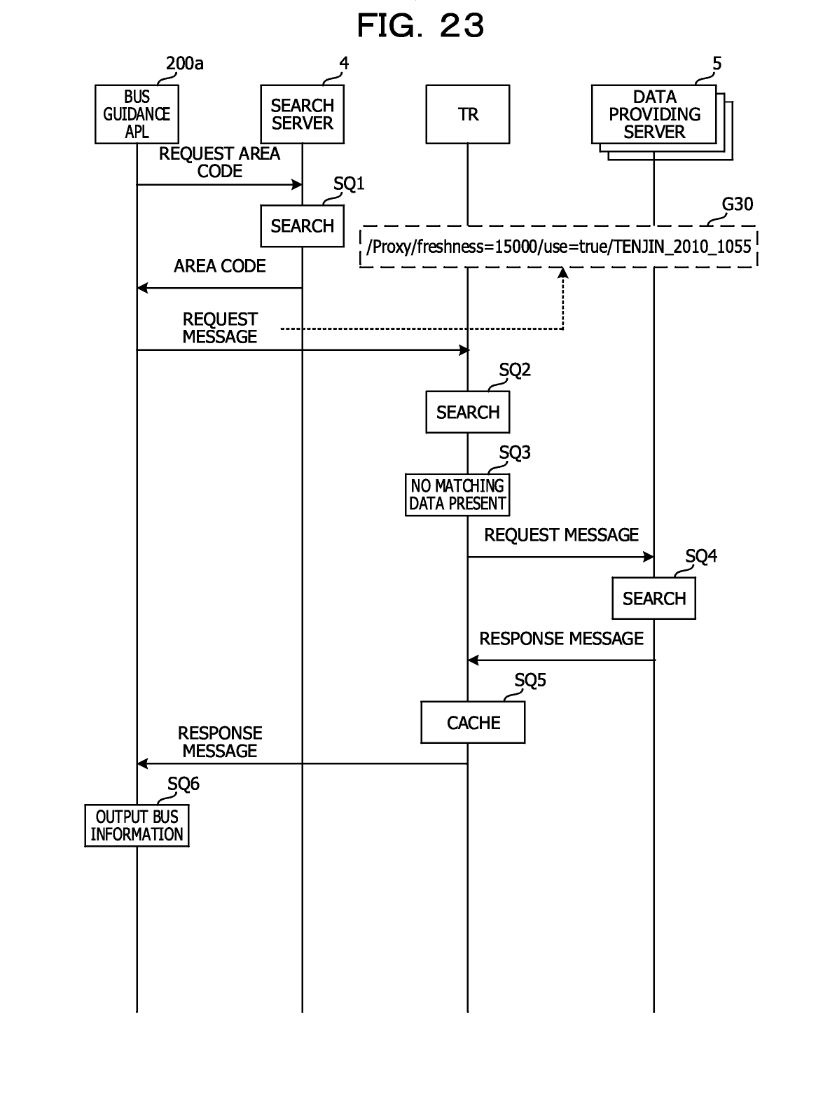

FIG. 23 is a sequence diagram illustrating an example of operation of the traffic information system when no relevant data is cached in the relay device TR. The bus guidance application 200a requests an area code from the search server 4. The search server 4 searches the area code database 40 for the area code (symbol SQ1) and transmits the area code to the bus guidance application 200a.

Next, the bus guidance application 200a generates a request message indicated by symbol G30 and transmits the request message to the relay device TR. The request message includes the function ID “Proxy”, the use condition “freshness=15000”, the processing information “use=true”, and the name “Tenjin_2010_1055”, as an example.

The relay device TR searches for cached data that corresponds to the name “Tenjin_2010_1055” and satisfies the use condition “freshness=15000” (symbol SQ2). Since, as a result of the search, no corresponding cached data is present (symbol SQ3), the relay device TR generates and transmits a request message to the data providing servers 5.

Upon receiving the request message, the data providing servers 5 searches the congestion information database 50 for congestion information that matches the name “Tenjin_2010_1055” and satisfies the use condition “freshness=15000” (symbol SQ4). The data providing servers 5 generates and transmits a response message including the searched congestion information to the relay device TR.

Upon receiving the response message from the data providing server 5, the relay device TR caches the congestion information and registers the cached time in the database 131 (symbol SQ5). The relay device TR generates and transmits a response message including the congestion information to the bus guidance application 200a. Upon receiving the response message, the bus guidance application 200a generates bus information related to a bus first to arrive and displays the bus information based on the congestion information (symbol SQ6).

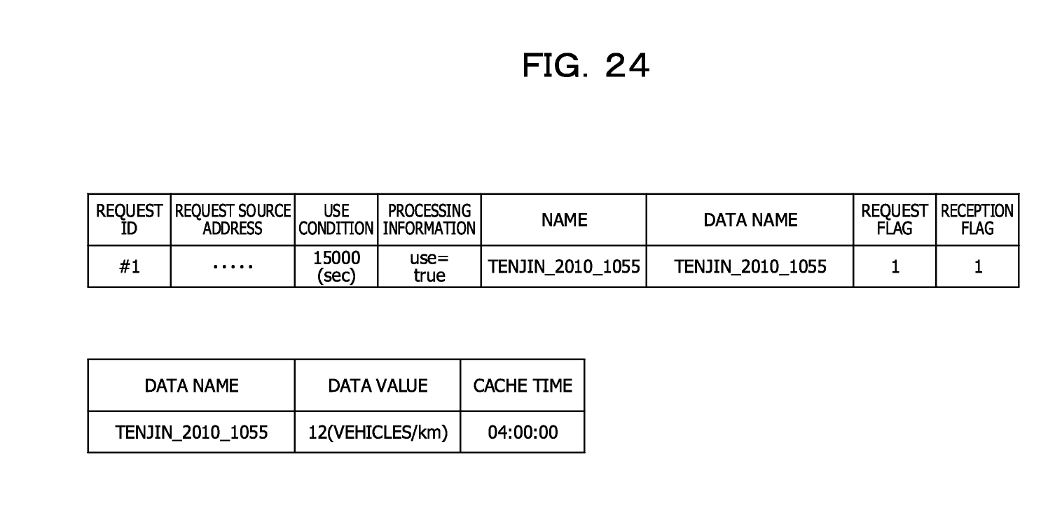

FIG. 24 illustrates the request management table 130 and the database 131 in the present example. In the request management table 130, “freshness=15000 (sec)” is registered as the use condition, and “use=true” is registered as the processing information. In addition, “Tenjin_2010_1055” is registered as the name and as the data name.

In the database 131, 12 (vehicles / km) which is the number of vehicles per kilometer (km), and “04:00:00” which is the cached time, are registered as the congestion information. Therefore, if the current time is, for example, 11 o'clock, the congestion information does not satisfy the use condition “freshness=15000 (sec)”.

Accordingly, in the present example, since no cached data that matches the name “Tenjin_2010_1055” and satisfies the use condition “freshness=15000” is present in the database 131, the request flag is set to “1”. Therefore, the relay device TR generates and transmits a request message in which the name “Tenjin_2010_1055” is specified. In addition, due to receiving the response message that corresponds to the request message, the reception flag has been set to “1”.

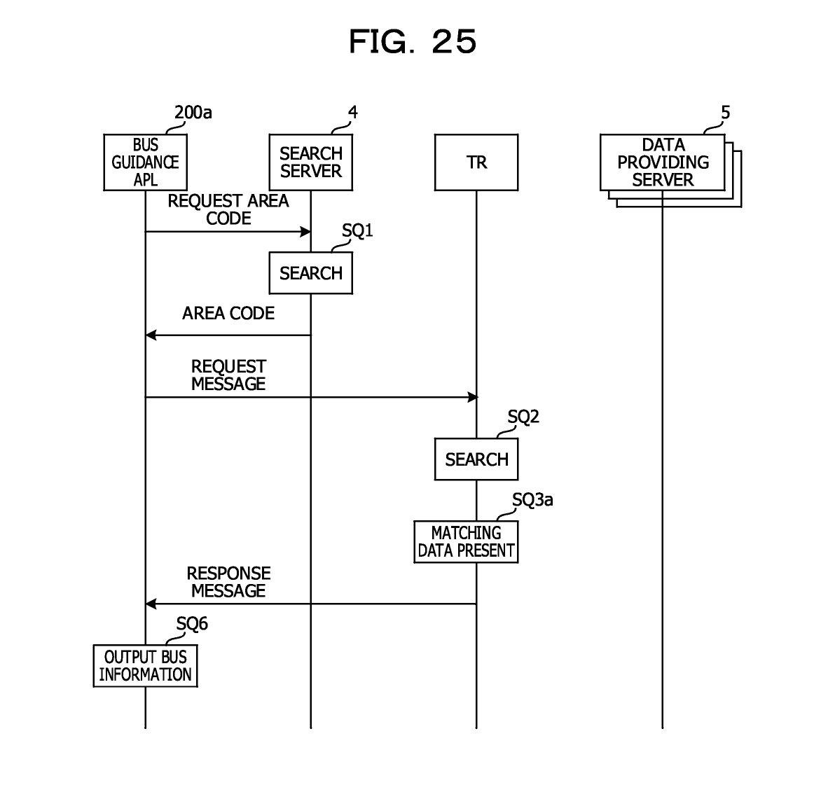

FIG. 25 is a sequence diagram illustrating an example of operation of the traffic information system when the relevant data has been cached in the relay device TR. In FIG. 25, processing and state common to those in the FIG. 23 are assigned the same symbols, and the description thereof are omitted.

The relay device TR searches for cached data that matches the name “Tenjin_2010_1055” and satisfies the use condition “freshness=15000” (the symbol SQ2). Since, as a result of the search, there is matching cached data (symbol SQ3a), the relay device TR generates and transmits a response message that includes the cached data to the bus guidance application 200a.

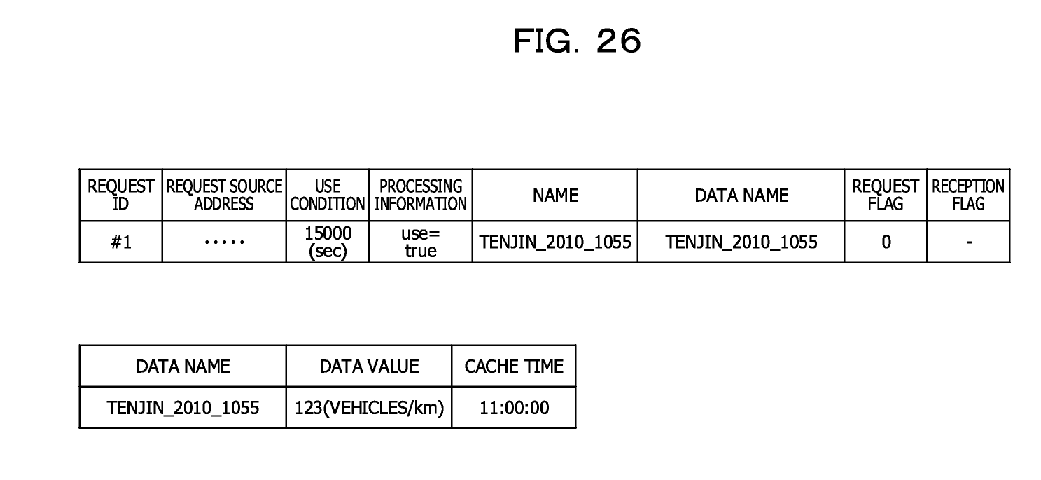

FIG. 26 illustrates the request management table 130 and the database 131 in the present example. In the request management table 130, “freshness=15000 (sec)” is registered as the use condition, and “use=true” is registered as the processing information. In addition, “Tenjin_2010_1055” is registered as the name and as the data name.

As the congestion information, 123 (vehicles / km) and “11:00:00” which is the cached time, are registered in the database 131. Therefore, if the current time is, for example, 11 o'clock, the congestion information satisfies the use condition “freshness=15000 (sec)”.

Accordingly, the request flag is set to “0” in the present example, since cached data that matches the name “Tenjin_2010_1055” and satisfies the use condition “freshness=15000” is present in the database 131. Therefore, the relay device TR does not transmit a request message specifying the name “Tenjin_2010_1055”, and the relay device TR generates and transmits a response message that includes the cached data.

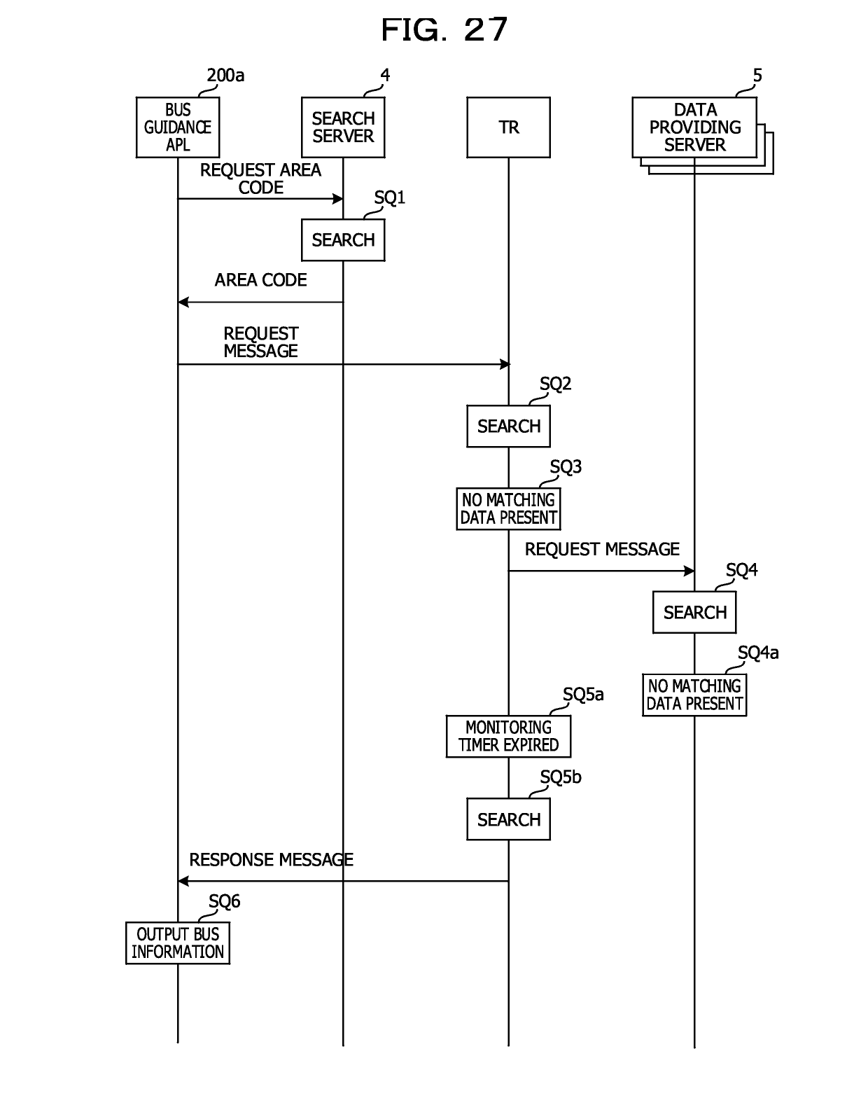

FIG. 27 is a sequence diagram illustrating an example of operation of the traffic information system when no response message is received from the data providing servers 5. In FIG. 27, processing and state common to those in the FIG. 23 are assigned the same symbols, and the description thereof are omitted.

Upon receiving a request message, the data providing servers 5 searches the congestion information database 50 for congestion information that matches the name “Tenjin_2010_1055” and satisfies the use condition “freshness=15000” (the symbol SQ4). Since, as a result of the search, no congestion information that matches the name “Tenjin_2010_1055” and satisfies the use condition “freshness=15000” (symbol SQ4a), the data providing servers 5 generates no response message.

The relay device TR determines whether a response message has not been received, with the expiry of the monitoring timer 102c (symbol SQ5a). The relay device TR searches the database 131 for cached data that does not satisfy the use condition “freshness=15000” but matches the name “Tenjin_2010_1055” (symbol SQ5b), in accordance with the processing information “use=true”. The relay device TR generates and transmits a response message that includes the searched cached data to the bus guidance application 200a. Note that if the processing information is “use=false”, the relay device TR does not perform the search of cached data (the symbol SQ5b) nor transmits a response message.

Note that the above-mentioned processing functions may be realized by a computer. In that case, a program that describes processing details for functions to be included in a processing apparatus is provided. The above-mentioned processing functions are implemented on the computer by executing the program on the computer. The program in which the processing details are described may be recorded in a computer-readable recording medium (however, excluding carrier waves).

In a case in which the program is distributed, the program is, for example, marketed in the form of portable recording media such as a digital versatile disc (DVD) and a Compact Disc read only memory (CD-ROM), in which the program is recorded. In addition, the program may be stored in a storage device in a server computer, and the program may be transferred to another computer from the server computer via a network.

The computer to execute the program stores, for example, the program recorded in the portable recording media or the program transferred from the server computer, in the computer's own storage device. The computer then reads the program from its own storage device, and executes processing following the program. Note that the computer is also capable of directly reading the program from the portable recording media to execute processing following the program. Alternatively, the computer may execute processing successively according to the program each time it

is transferred from the server computer.

The above-mentioned embodiments are preferred practical examples of the present technology. In this regard, however, the present technology is not limited to these and may be variously modified or altered and implemented without departing from the scope of the present technology.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store data and time information indicating the time of storing the data; and
a processor coupled to the memory and configured to:
receive, from a request source device, a request message including an identifier corresponding to the data and a condition related to time corresponding to the data;
search the memory for required data that corresponds to the identifier and the time information satisfying the condition;
acquire the required data from the memory when the required data is stored in the memory;
acquire the required data from another device when the required data is not stored in the memory; and
transmit the required data to the request source device.

2. The information processing apparatus according to claim 1, wherein
when the data stored in the storage unit is the data that corresponds to the identifier and that corresponds to the time information not satisfying the condition, the required data is acquired from the other device.

3. The information processing apparatus according to claim 1, wherein
the request message includes restriction condition for restricting the data to be transmitted to the request source device, and
data that is included in the required data and that satisfies the restriction condition is transmitted to the request source device.

4. The information processing apparatus according to claim 1, wherein
the request message includes control information indicating whether or not to transmit data acquired from the storage unit when the required data is not acquired from the other device, and
when the data is not acquired from the other device, data that is included in data stored in the storage unit and that corresponds to the identifier and the time information not satisfying the condition is transmitted to the request source device, based on the control information.

5. An information processing system comprising:
an information processing apparatus; and
a request source device configured to send a request message including an identifier corresponding to data and a condition related to time corresponding to the data, wherein the information processing apparatus includes:
a memory configured to store the data and time information indicating the time of storing the data;
a processor coupled to the memory and configured to:
receive, from a request source device, a request message including an identifier corresponding to the data and a condition related to time corresponding to the data;
search the memory for required data that corresponds to the identifier and the time information satisfying the condition;
acquire the required data from the memory when the required data is stored in the memory;
acquire the required data from another device when the required data is not stored in the memory; and
transmit the required data to the request source device.

6. A data providing method for an information processing apparatus including a memory configured to store data and time information indicating the time of storing the data, and a processor coupled to the memory, comprising:
receiving, from a request source device, a request message including an identifier corresponding to the data and a condition related to time corresponding to the data;
searching the memory for required data that corresponds to the identifier and the time information satisfying the condition;
acquiring the required data from the memory when the required data is stored in the memory;
acquiring the required data from another device when the required data is not stored in the memory; and
transmitting the required data to the request source device.
